(19) United States
(12) Patent Application Publication
(10) Pub. No.: US 2025/0167963 A1
(43) Pub. Date: May 22, 2025

(54) DIFFERENTIAL DEMODULATION REFERENCE SIGNAL BASED CHANNEL QUALITY REPORTING

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/835,234

(22) PCT Filed: Mar. 28, 2022
(86) PCT No.: PCT/CN2022/083297

§ 371 Date: Aug. 1, 2024

(51) Int. Cl. H04L 5/00; H04L 1/1812

(52) U.S. Cl. CPC H04L 5/0057; H04L 1/1812; H04L 5/0044; H04L 5/0048; H04L 5/0055

(57) ABSTRACT

Methods, systems, and devices for wireless communications at a user equipment (UE) are described. The UE may receive a synchronization signal block or channel state information reference signal. The UE may transmit a channel state information report including a first indication of channel quality associated with the synchronization signal block or channel state information reference signal. The UE may receive a demodulation reference signal that is quasi co-located with the synchronization signal block or channel state information reference signal and associated with a physical downlink shared channel. The UE may transmit a hybrid automatic repeat request acknowledgment message or channel state information report including a second indication of channel quality associated with the demodulation reference signal of the physical downlink shared channel. The second indication of channel quality may include a differential measurement that is relative to the first indication of channel quality.

### CROSS REFERENCE

The present Application is a 371 national phase filing of International PCT Application No. PCT/CN2022/083297 by LI et al., entitled “DIFFERENTIAL DEMODULATION REFERENCE SIGNAL BASED CHANNEL QUALITY REPORTING,” filed Mar. 28, 2024, which is assigned to the assignee hereof, and which is expressly incorporated by reference in its entirety herein.

### FIELD OF TECHNOLOGY

The present disclosure relates to wireless communications at a user equipment (UE), including differential demodulation reference signal based channel quality reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications system, a wireless device may report channel quality based on a demodulation reference signal (DMRS). However, methods for such channel quality reporting schemes may be improved/deficient.

### SUMMARY

The described techniques relate to improved methods, systems, devices, and apparatuses that support differential demodulation reference signal based channel quality reporting. For example, a user equipment (UE) The UE may receive a synchronization signal block or channel state information reference signal. The UE may transmit a channel state information report including a first indication of channel quality associated with the synchronization signal block or channel state information reference signal. The UE may receive a demodulation reference signal that is quasi co-located with the synchronization signal block or channel state information reference signal and associated with a physical downlink shared channel. The UE may transmit a hybrid automatic repeat request acknowledgment message or channel state information report including a second indication of channel quality associated with the demodulation reference signal of the physical downlink shared channel. The second indication of channel quality may include a differential measurement that is relative to the first indication of channel quality.

A method for wireless communications at a user equipment (UE) is described. The method may include receiving a synchronization signal block or channel state information reference signal, transmitting a channel state information report including a first indication of channel quality associated with the synchronization signal block or channel state information reference signal, receiving a demodulation reference signal that is quasi co-located with the synchronization signal block or channel state information reference signal and associated with a physical downlink shared channel, and transmitting a hybrid automatic repeat request acknowledgment message including a second indication of channel quality associated with the demodulation reference signal of the physical downlink shared channel, where the second indication of channel quality includes a differential measurement that is relative to the first indication of channel quality.

An apparatus for wireless communications at a UE is described. The apparatus may include a processor, memory coupled with the processor, and instructions stored in the memory. The instructions may be executable by the processor to cause the apparatus to receive a synchronization signal block or channel state information reference signal, transmit a channel state information report including a first indication of channel quality associated with the synchronization signal block or channel state information reference signal, receive a demodulation reference signal that is quasi co-located with the synchronization signal block or channel state information reference signal and associated with a physical downlink shared channel, and transmit a hybrid automatic repeat request acknowledgment message including a second indication of channel quality associated with the demodulation reference signal of the physical downlink shared channel, where the second indication of channel quality includes a differential measurement that is relative to the first indication of channel quality.

Another apparatus for wireless communications at a UE is described. The apparatus may include means for receiving a synchronization signal block or channel state information reference signal, means for transmitting a channel state information report including a first indication of channel quality associated with the synchronization signal block or channel state information reference signal, means for receiving a demodulation reference signal that is quasi co-located with the synchronization signal block or channel state information reference signal and associated with a physical downlink shared channel, and means for transmitting a hybrid automatic repeat request acknowledgment message including a second indication of channel quality associated with the demodulation reference signal of the physical downlink shared channel, where the second indication of channel quality includes a differential measurement that is relative to the first indication of channel quality.

A non-transitory computer-readable medium storing code for wireless communications at a UE is described. The code may include instructions executable by a processor to receive a synchronization signal block or channel state information reference signal, transmit a channel state information report including a first indication of channel quality associated with the synchronization signal block or channel state information reference signal, receive a demodulation reference signal that is quasi co-located with the synchronization signal block or channel state information reference signal and associated with a physical downlink shared channel, and transmit a hybrid automatic repeat request acknowledgment message including a second indication of channel quality associated with the demodulation reference signal of the physical downlink shared channel, where the second indication of channel quality includes a differential measurement that is relative to the first indication of channel quality.

Some examples of the method, apparatuses, and non-transitory computer-readable medium described herein may further include operations, features, means, or instructions for receiving downlink control information indicating that the UE may be to provide differential reporting of channel quality associated with the physical downlink shared channel, where transmitting the hybrid automatic repeat request acknowledgment message may be based on receiving the downlink control information.

In some examples of the method, apparatuses, and non-transitory computer-readable medium described herein, the downlink control information includes a field that indicates a quantity of bits for transmitting the hybrid automatic repeat request acknowledgement message.

Some examples of the method, apparatuses, and non-transitory computer-readable medium described herein may further include operations, features, means, or instructions for receiving radio resource control signaling associated with a hybrid automatic repeat request process identifier, the radio resource control signaling indicating that the UE may be to provide differential reporting of channel quality associated with the physical downlink shared channel, where transmitting the hybrid automatic repeat request acknowledgement message may be based on receiving the radio resource control signaling.

In some examples of the method, apparatuses, and non-transitory computer-readable medium described herein, the radio resource control signaling indicates a quantity of bits for transmitting the hybrid automatic repeat request acknowledgement message.

In some examples of the method, apparatuses, and non-transitory computer-readable medium described herein, transmitting the hybrid automatic repeat request acknowledgement message may include operations, features, means, or instructions for transmitting a multi-bit field including a first bit that indicates a positive acknowledgement or a negative acknowledgement and a second bit that indicates the differential measurement.

In some examples of the method, apparatuses, and non-transitory computer-readable medium described herein, the second bit of the multi-bit field indicates that a signal strength of the demodulation reference signal may be higher than, lower than, or equal to a signal strength associated with the first indication of channel quality.

In some examples of the method, apparatuses, and non-transitory computer-readable medium described herein, the second bit of the multi-bit field indicates that a signal strength of the demodulation reference signal differs from a signal strength associated with the first indication of channel quality by a value that may be less than, equal to, or greater than a threshold value.

Some examples of the method, apparatuses, and non-transitory computer-readable medium described herein may further include operations, features, means, or instructions for receiving one or more additional demodulation reference signals during an averaging time window defined by a beginning symbol and an end symbol, the one or more additional demodulation reference signals being quasi co-located with the synchronization signal block or channel state information reference signal and associated with the same or another physical downlink shared channel, where the second indication of channel quality may be based on an average of a signal strength of the demodulation reference signal and signal strengths of at least one of the one or more additional demodulation reference signals.

In some examples of the method, apparatuses, and non-transitory computer-readable medium described herein, the demodulation reference signal may be received during a time window delineated by a beginning symbol and an end symbol.

Some examples of the method, apparatuses, and non-transitory computer-readable medium described herein may further include operations, features, means, or instructions for receiving a second demodulation reference signal that may be quasi co-located with the synchronization signal block or channel state information reference signal and associated with the physical downlink shared channel and transmitting a second hybrid automatic repeat request acknowledgment message including a third indication of channel quality associated with the second demodulation reference signal of the physical downlink shared channel, where the third indication of channel quality includes a differential measurement that may be relative to the second indication of channel quality or the first indication of channel quality.

Some examples of the method, apparatuses, and non-transitory computer-readable medium described herein may further include operations, features, means, or instructions for receiving a third demodulation reference signal that may be quasi co-located with the synchronization signal block or channel state information reference signal and associated with the physical downlink shared channel and transmitting a third hybrid automatic repeat request acknowledgment message including a fourth indication of channel quality associated with the third demodulation reference signal of the physical downlink shared channel, where the fourth indication of channel quality includes a differential measurement that may be relative to the third indication of channel quality, the second indication of channel quality, or the first indication of channel quality.

In some examples of the method, apparatuses, and non-transitory computer-readable medium described herein, the first indication of channel quality, the second indication of channel quality, or both, include a layer one reference signal received power, a layer one signal to interference and noise ratio, a channel quality indicator, or any combination thereof.

A method for wireless communications at a UE is described. The method may include receiving a synchronization signal block or channel state information reference signal, transmitting a channel state information report including a first indication of channel quality, receiving control signaling indicating that the UE is to provide differential reporting of channel quality based on at least one demodulation reference signal associated with a physical downlink shared channel, receiving the demodulation reference signal that is quasi co-located with the synchronization signal block or channel state information reference signal and associated with the physical downlink shared channel, and transmitting a second channel state information report including a second indication of channel quality associated with the demodulation reference signal of the physical downlink shared channel based on receiving the control signaling, where the second indication of channel quality includes a differential measurement that is relative to the first indication of channel quality.

An apparatus for wireless communications at a UE is described. The apparatus may include a processor, memory coupled with the processor, and instructions stored in the memory. The instructions may be executable by the processor to cause the apparatus to receive a synchronization signal block or channel state information reference signal, transmit a channel state information report including a first indication of channel quality, receive control signaling indicating that the UE is to provide differential reporting of channel quality based on at least one demodulation reference signal associated with a physical downlink shared channel, receive the demodulation reference signal that is quasi co-located with the synchronization signal block or channel state information reference signal and associated with the physical downlink shared channel, and transmit a second channel state information report including a second indication of channel quality associated with the demodulation reference signal of the physical downlink shared channel based on receiving the control signaling, where the second indication of channel quality includes a differential measurement that is relative to the first indication of channel quality.

Another apparatus for wireless communications at a UE is described. The apparatus may include means for receiving a synchronization signal block or channel state information reference signal, means for transmitting a channel state information report including a first indication of channel quality, means for receiving control signaling indicating that the UE is to provide differential reporting of channel quality based on at least one demodulation reference signal associated with a physical downlink shared channel, means for receiving the demodulation reference signal that is quasi co-located with the synchronization signal block or channel state information reference signal and associated with the physical downlink shared channel, and means for transmitting a second channel state information report including a second indication of channel quality associated with the demodulation reference signal of the physical downlink shared channel based on receiving the control signaling, where the second indication of channel quality includes a differential measurement that is relative to the first indication of channel quality.

A non-transitory computer-readable medium storing code for wireless communications at a UE is described. The code may include instructions executable by a processor to receive a synchronization signal block or channel state information reference signal, transmit a channel state information report including a first indication of channel quality, receive control signaling indicating that the UE is to provide differential reporting of channel quality based on at least one demodulation reference signal associated with a physical downlink shared channel, receive the demodulation reference signal that is quasi co-located with the synchronization signal block or channel state information reference signal and associated with the physical downlink shared channel, and transmit a second channel state information report including a second indication of channel quality associated with the demodulation reference signal of the physical downlink shared channel based on receiving the control signaling, where the second indication of channel quality includes a differential measurement that is relative to the first indication of channel quality.

Some examples of the method, apparatuses, and non-transitory computer-readable medium described herein may further include operations, features, means, or instructions for receiving the control signaling including a downlink grant for a downlink transmission, where the demodulation reference signal may be associated with the downlink transmission.

Some examples of the method, apparatuses, and non-transitory computer-readable medium described herein may further include operations, features, means, or instructions for receiving the control signaling including an uplink grant, receiving radio resource control signaling indicating a channel state information report configuration that indicates one or more demodulation reference signals upon which the second indication of channel quality may be to be based, where the one or more demodulation reference signals may be only quasi co-located with the synchronization signal block or channel state information reference signal, and where the second indication of channel quality may be based on the indicated one or more demodulation reference signals and the synchronization signal block or channel state information reference signal.

Some examples of the method, apparatuses, and non-transitory computer-readable medium described herein may further include operations, features, means, or instructions for receiving the control signaling including an uplink grant and an indication that the UE may be to provide the differential reporting of channel based on the synchronization signal block or channel state information reference signal.

Some examples of the method, apparatuses, and non-transitory computer-readable medium described herein may further include operations, features, means, or instructions for receiving the demodulation reference signal during a time period that occurs before receiving the control signaling.

Some examples of the method, apparatuses, and non-transitory computer-readable medium described herein may further include operations, features, means, or instructions for transmitting the second channel state information report via a second part of a two-part channel state information report.

Some examples of the method, apparatuses, and non-transitory computer-readable medium described herein may further include operations, features, means, or instructions for receiving radio resource control signaling including a channel state information report configuration indicating that the UE may be to provide periodic channel state information reports including differential reporting of channel state information associated with the physical downlink shared channel and transmitting the periodic channel state information reports based on receiving the radio resource control signaling, each periodic channel state information report including an indication of channel quality of the physical downlink shared channel based on a last-received demodulation reference signal.

In some examples of the method, apparatuses, and non-transitory computer-readable medium described herein, where the channel state information report configuration indicates that the differential measurement may be to be made relative to the first indication of channel quality.

Some examples of the method, apparatuses, and non-transitory computer-readable medium described herein may further include operations, features, means, or instructions for transmitting the second channel state information report, where the second indication of channel quality may be based on an average of a signal strength of the demodulation reference signal and signal strengths of one or more additional demodulation reference signals that may be quasi co-located with the synchronization signal block or channel state information reference signal and received after a most-recently transmitted previous channel state information report and before a time buffer that precedes transmitting the second channel state information report.

Some examples of the method, apparatuses, and non-transitory computer-readable medium described herein may further include operations, features, means, or instructions for receiving one or more additional demodulation reference signals during an averaging time window delineated by a beginning symbol and an end symbol, the one or more additional demodulation reference signals that may be quasi co-located with the synchronization signal block or channel state information reference signal and associated with the same or additional physical downlink shared channel, where the second indication of channel quality may be based on an average of a signal strength of the demodulation reference signal and signal strengths of at least one of the one or more additional demodulation reference signals.

In some examples of the method, apparatuses, and non-transitory computer-readable medium described herein, where the demodulation reference signal may be received during a time window delineated by a beginning symbol and an end symbol.

In some examples of the method, apparatuses, and non-transitory computer-readable medium described herein, the first indication of channel quality, the second indication of channel quality, or both, include a layer one reference signal received power, a layer one signal to interference and noise ratio, a channel quality indicator, or any combination thereof.

### BRIEF DESCRIPTION OF THE DRAWINGS

FIG. 1 illustrates an example of a wireless communications system that supports differential demodulation reference signal based channel quality reporting in accordance with one or more aspects of the present disclosure.

FIG. 2 illustrates an example of a wireless communications system that supports differential demodulation reference signal based channel quality reporting in accordance with one or more aspects of the present disclosure.

FIG. 3 illustrates an example of a differential channel quality reporting scheme that supports differential demodulation reference signal based channel quality reporting in accordance with one or more aspects of the present disclosure.

FIGS. 4A and 4B illustrate an example of a differential channel quality reporting scheme that supports differential demodulation reference signal based channel quality reporting in accordance with one or more aspects of the present disclosure.

FIG. 5 illustrates an example of a differential channel quality reporting scheme that supports differential demodulation reference signal based channel quality reporting in accordance with one or more aspects of the present disclosure.

FIG. 6 illustrates an example of a process flow that supports differential demodulation reference signal based channel quality reporting in accordance with one or more aspects of the present disclosure.

FIG. 7 illustrates an example of a process flow that supports differential demodulation reference signal based channel quality reporting in accordance with one or more aspects of the present disclosure.

FIGS. 8 and 9 show block diagrams of devices that support differential demodulation reference signal based channel quality reporting in accordance with one or more aspects of the present disclosure.

FIG. 10 shows a block diagram of a communications manager that supports differential demodulation reference signal based channel quality reporting in accordance with one or more aspects of the present disclosure.

FIG. 11 shows a diagram of a system including a device that supports differential demodulation reference signal based channel quality reporting in accordance with one or more aspects of the present disclosure.

FIGS. 12 and 13 show flowcharts illustrating methods that support differential demodulation reference signal based channel quality reporting in accordance with one or more aspects of the present disclosure.

### DETAILED DESCRIPTION

In the course of wireless communications, a wireless device may engage in beam management procedures. However, if such procedures are performed frequently, power consumption (e.g., at a UE) may be increased. Therefore, wireless devices may engage in beam prediction. For example, a network entity engages in beam prediction to predict beams that may be used in the future to communicate with a UE. In some stationary or low-speed scenarios, a beam index may not change over a period of time. Thus, beam prediction may be employed and may be performed at larger intervals (e.g., 80 ms periods instead of 20 ms periods). However, such beam prediction approaches still may involve levels of uncertainty and beam predictions may be of limited accuracy.

To reduce or eliminate such uncertainty and inaccuracy, a UE engages in differential reporting of channel quality information. For example, a network entity transmits reference signals (e.g., DMRSs) to the UE that are QCL'd with a synchronization signal block (SSB), channel state information reference signal (CSI-RS), or other signal. Since beam-switching may be less frequent (e.g., in a stationary or low-speed scenario) and multiple DMRSs and other transmissions may be QCL'd with a single SSB, differential reporting of channel quality information associated with the various DMRSs may be employed. In such a report, a differential indication of channel quality may use an earlier indication (e.g., an absolute indication) of channel quality (e.g., a channel state information (CSI) report that includes an indication or measurement of channel quality) as a reference point and indicate a change (or lack thereof) of current channel quality relative to the reference point. For example, a differential report may indicate that a signal strength of a DMRS has decreased compared to a previously measured signal strength of another, previously-received signal (e.g., a DMRS or other reference signal, whose signal strength may be reported in a CSI report or other channel quality reporting). Such differential reporting may be done through HARQ-ACK based messaging in which an ACK/NACK and differential channel quality information are jointly reported. Such differential reporting may be done through CSI reports (e.g., aperiodic, persistent, or semi-persistent CSI reports) that may be triggered through DCI grants. In this way, power consumption and reporting overhead (e.g., at the UE) may be reduced.

Aspects of the disclosure are initially described in the context of wireless communications systems. Aspects of the disclosure are then described with reference to a system diagram, channel quality reporting schemes, and a process flow. Aspects of the disclosure are further illustrated by and described with reference to apparatus diagrams, system diagrams, and flowcharts that relate to differential demodulation reference signal based channel quality reporting.

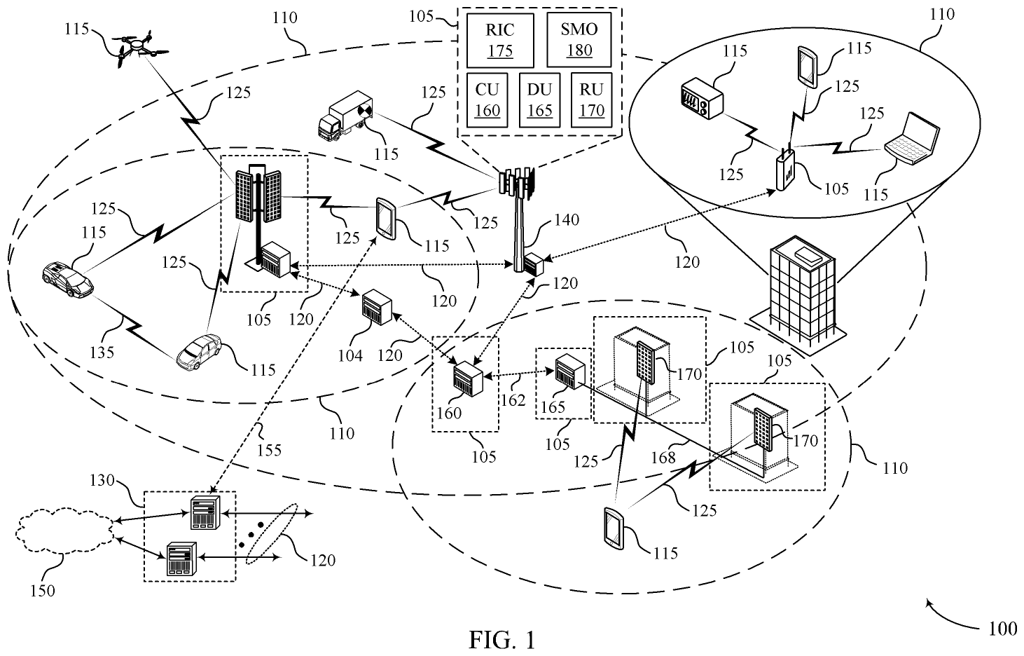

FIG. 1 illustrates an example of a wireless communications system 100 that supports differential demodulation reference signal based channel quality reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support differential demodulation reference signal based channel quality reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N^{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some implementations, a UE 115 and a network entity 105 may support one or more signaling- or configuration-based mechanisms according to which the UE 115 and the network entity 105 may engage in differential reporting of channel quality based on reference signal measurements (e.g., DMRS measurements). For example, the UE 115 may receive an SSB or CSI-RS and may further transmit a first indication of channel quality (e.g., of PDSCH). In some cases, such an indication may be based on the SSB, the CSI-RS, other signaling (including other reference signals, such as a DMRS), or any combination thereof. Such a report may include measurements or indications of channel conditions or quality, and may include an absolute measurement (e.g., an absolute measurement of signal strength, sometimes expressed in dB). The UE 115 may receive a DMRS that is QCL'd with the SSB or CSI-RS and may further measure channel conditions or quality based on the DMRS. The UE 115 may transmit signaling or a report that uses a differential measurement or expression (e.g., made relative to another report, such as the CSI report or other channel quality reporting, sometimes indicating a change relative to the earlier report, such as a change expressed in dB). In some examples, the UE 115 may make such reports in or in connection with a HARQ-ACK message, which may include a bit or bits for indicating the differential measurement or differential report. Additionally, or alternatively, the UE 115 may make the differential report using a second CSI report. In some examples, the UE 115 may be triggered to prepare the second CSI report or other channel quality reporting based on received control signaling. In this way, the UE 115 and the network entity 105 may engage in differential reporting of channel quality that may aid the network entity 105 to refine a beam prediction operation or one or more other wireless communications operations.

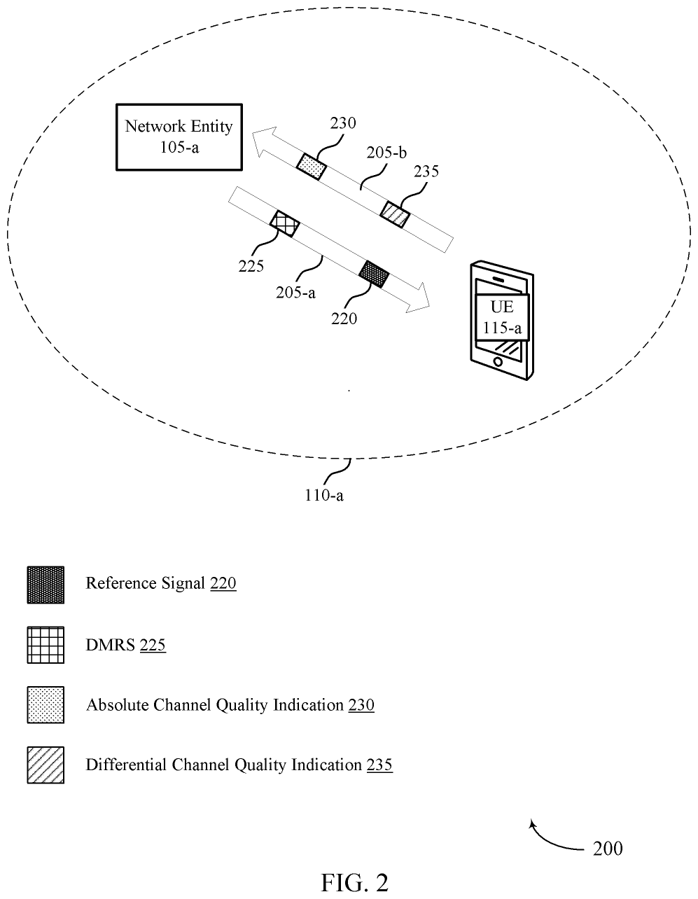

FIG. 2 illustrates an example of a wireless communications system 200 that supports differential demodulation reference signal based channel quality reporting in accordance with one or more aspects of the present disclosure. The wireless communications system 200 may include a network entity 105-a that may be an example of the one or more of the network entities 105 discussed in relation to FIG. 1. The wireless communications system 200 may include UE 115-a that may be an example of UE 115 discussed in relation to FIG. 1. In some examples, the UE 115a may be located in a geographic coverage area 110-a that may be associated with the network entity 105-a. The network entity 105-a and UE 115-a may communicate via one or more downlink communication links 205-a and one or more uplink communication links 205-b.

In the course of wireless communications, the network entity 105-a may engage in beam management operations in attempts to better manage beam selection, beamforming, or both. However, in some cases, frequent beam management operations (e.g., including reporting of parameters, such as SSB-Index-RSRP or cri-RSRP) may consume UE-specific overheads, consume additional UE power, or both. In many stationary or low-speed scenarios, a top beam index may not change over periods of time (e.g., hundreds of ms). In some such cases, it may be beneficial to reduce overhead, power consumption, or both, by trying to predict one or more elements or parameters (e.g., at the network entity 105-a). For example, the network entity 105-a may predict parameters or information such as a strongest SSB Resource Indicator (SSBRI), a strongest CSI-RS Resource Indicator (CRI), an associated RSRP or other measure of signal strength, a possibility of another SSBRI or CRI being a “top” or strongest beam (e.g., via softmax output), a mean of an RSRP of one or more SSBRIs, CRIs, or both, a variance of an RSRP of one or more SSBRIs, CRIs, or both, or any combination thereof. In some implementations, an artificial intelligence (AI) based model may be used to predict one or more such quantities. For example, such an approach may utilize one or more convolutional neural networks (CNN), one or more recurrent neural networks (RNN), one or more long short-term memory networks, or any combination thereof. Other types of AI models may also be used, and are contemplated by the approached disclosed herein.

In some examples, one or more DMRSs may be available to the UE 115-a. The UE 115-a may make one or more measurements of such DMRSs, and may report such measurements (e.g., to the network entity 105-a) to aid in a beam prediction process as described herein. In some examples, the UE 115-a may engage in a simplified reporting scheme to aid in the beam prediction operations. For example, the UE 115-a may report persistent, semi-persistent, or aperiodic reporting (e.g., L1 reporting) between other reports, such as adjacent full SSB-Index-RSRP reports, cri-RSRP reports, or other reports. For example, the UE 115-a may engage in differential L1-RSRP reporting for a beam associated with a PDSCH DMRS that is QCL'd with a recently-reported (or last-reported) SSBRI with respect to the SSB-Index-RSRP. Additionally, or alternatively, such approaches may also be used in connection with a CRI and a cri-RSRP report. By engaging in such differential reporting, the UE 115-a may consume less power, may utilize less overhead (e.g., reporting overhead), or both, as a beam sweeping procedure may not be used. The subject matter described herein includes configuration and signaling approaches to enable such differential reporting.

The UE 115-a may receive one or more reference signals 220 (e.g., for measuring a quality or signal strength associated with a PDSCH), and may transmit the absolute channel quality indication 230. The absolute channel quality indication 230 may be a CSI report, a HARQ-ACK message comprising an indication of channel quality, or another indication of channel quality. The absolute channel quality indication 230 may include an indication of signal strength (e.g., measured in dB) that may be obtained through one or more measurements made by the UE 115-a based on the reference signal 220.

The UE 115-a may receive the DMRS 225 (e.g., from the network entity 105-a) in accordance with the approaches described herein. The UE 115-a may make one or more measurements based on the DMRS 225 (e.g., to measure or obtain an indication of channel quality of the channel used to transmit the DMRS 225). Based on these one or more measurements, the UE 115-a may prepare the differential channel quality indication 235. The differential channel quality indication 235 may include an indication of the strength or quality of the DMRS 225 expressed as a differential value relative to the absolute channel quality indication 230. For example, if a signal strength of the reference signal 220 was measured to be −89 dBm, and a signal strength of the DMRS 225 was measured to be −85 dBm, the differential channel quality indication 235 may include an indication of +4 dBm. Additionally, or alternatively, the differential channel quality indication 235 may include an indication that the signal strength increased (e.g., a 1 value in a bit field may indicate an increase, optionally made relative to a threshold). In this way, the UE 115-a may engage in differential reporting to aid the network entity 105-a in beam prediction procedures while reducing power consumption, reporting overhead, or both.

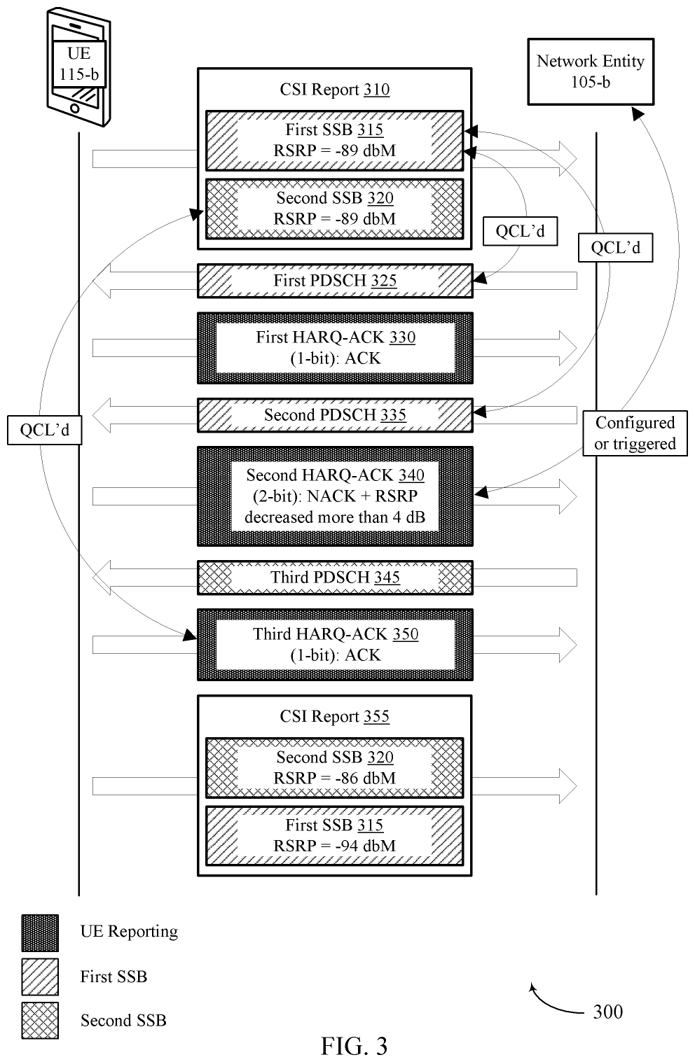

FIG. 3 illustrates an example of a differential channel quality reporting scheme 300 that supports differential demodulation reference signal based channel quality reporting in accordance with one or more aspects of the present disclosure. The differential channel quality reporting scheme 300 may involve the network entity 105-b that may be an example of one or more of the network entities 105 discussed in relation to other figures. The differential channel quality reporting scheme 300 may involve the UE 115-a that may be an example of UEs discussed in relation to other figures.

In some implementations, the UE 115-b may transmit differential reporting of channel quality (e.g., to the network entity 105-b) in association with HARQ-ACK messaging. For example, the UE 115-b may transmit a differential measurement of channel quality (e.g., L1-RSRP, L1-SINR, CQI, other channel quality reporting, or any combination thereof) associated with at least one QCL source reference signal (e.g., a type-D QCL source reference signal, optionally of a PDSCH DMRS). The differential reference may be based on a recently reported measurement of channel quality (e.g., a recently reported L1-RSRP, L1-SINR, CQI, other channel quality reporting, or any combination thereof) of a source reference signal (e.g., a type-D QCL source reference signal). In some examples, the reported differential measurement may be based on, associated with, or may employ a HARQ-ACK feedback addressing a corresponding PDSCH, and such a differential measurement may be jointly reported with the positive acknowledgment (ACK) or negative acknowledgment (NACK).

For example, the UE 115-b may transmit the CSI report 310 to the network entity 105-b, and the CSI report 310 may indicate a signal strength of a first SSB 315 and a second SSB 320. In some examples, the CSI report 310 may be an example of or may include an absolute indication of channel quality. For example, the CSI report 310 may include an indication of signal strength of the first SSB 315 and the second SSB 320, as portrayed in FIG. 3. Such signal strengths may be indicated in dBm.

The UE 115-b may receive the first PDSCH 325, which may be QCL'd with the first SSB 315. In response, the UE 115-b may transmit the first HARQ-ACK 330, which may contain an ACK or NACK, and the first HARQ-ACK 330 may optionally be a 1-bit response. In some examples, the first HARQ-ACK 330 may not carry an indication of channel quality.

The UE 115-b may receive the second PDSCH 335 from the network entity 105-b, which may include or be associated with receiving a reference signal (e.g., a DMRS or other reference signal) from the network entity 105-b, and the UE 115-b may perform a measurement of such a reference signal. Such a reference signal may be QCL'd with the first SSB 315. In response, the UE 115-b may transmit the second HARQ-ACK 340, which may include both an ACK or NACK and the differential indication of signal quality (e.g., an amount of change in signal strength or quality, a direction of change in signal strength or quality, whether an amount of change in signal strength or quality does not meet, meets, or exceeds a threshold amount of change, one or more other indications of signal quality, or any combination thereof). For example, as shown in the example in the figure, the UE 115-b may transmit an indication that the RSRP of the DMRS associated with the second PDSCH 335, which is QCL'd with the first SSB 315, has decreased more than 4 dB (where the 4 dB may be an example of a threshold against which a change in signal strength or quality may be compared) when compared to the signal strength of an earlier signal, such as the first SSB 315.

In some examples, such differential reporting may be dynamically triggered. For example, feedback using the second HARQ-ACK 340 (e.g., including the differential reporting) may be dynamically triggered by one or more indications in control signaling (e.g., DCI). For example, the UE 115-b may identify whether to report a HARQ-ACK that does not contain a differential channel quality report (e.g., a 1-bit HARQ-ACK) or a HARQ-ACK that does contain a differential channel quality report (e.g., a 2-bit HARQ-ACK) based one or more indications in a DCI (e.g., a DCI that may schedule one or more transmissions, such as the second PDSCH 335). In some examples, such HARQ-ACK feedback may be based on one or more bits or bit fields in a DCI that may indicate whether the UE 115-b is to report a HARQ-ACK that does not contain a differential channel quality report (e.g., a 1-bit HARQ-ACK) or a HARQ-ACK that does contain a differential channel quality report (e.g., a 2-bit HARQ-ACK). One or more values may be set in the bits or bit fields in the DCI (e.g., by the network entity 105-b), and different such values may include different indications to the UE 115-b (e.g., a format for reporting, an indication to report relative to a threshold, an indication of such a threshold, an indication to report an amount of change, an indication to report a direction of change, other indications, or any combination thereof).

For example, a 2-bit HARQ-ACK may be used (e.g., for a codebook) instead of 1 bit, and different code points may include or be associated with different interpretations. In some examples, the designations of remain, increase, and decrease may refer to or may describe a change relative to a previously reported RSRP for a source reference signal associated with a type-D QCL of a DMRS of a PDSCH. In some examples, a codepoint of “00” may indicate a NACK and that an RSRP has remained constant or has increased. In some examples, a codepoint of “01” may indicate a NACK and that an RSRP has decreased. In some examples, a codepoint of “10” may indicate an ACK and that an RSRP has remained constant or has increased. In some examples, a codepoint of “11” may indicate an ACK and that an RSRP has decreased.

As discussed herein, differential reporting may be made relative to a threshold. For example, a codepoint of “00” may indicate a NACK and that an RSRP has increased or decreased less than X dBm. In some examples, a codepoint of “01” may indicate a NACK and that an RSRP has decreased more than X dBm. In some examples, a codepoint of “10” may indicate an ACK and that an RSRP has increased or decreased less than X dBm. In some examples, a codepoint of “11” may indicate an ACK and that an RSRP has decreased more than X dBm. In some examples, the value of X (e.g., a threshold value) may be a predefined value (e.g., in a wireless communications standard), may be configured by the network entity 105-b, may be calculated or recommended by the UE 115-b, or any combination thereof.

Additionally, or alternatively, such differential reporting may be configured. For example, the second HARQ-ACK 340 feedback (e.g., including the differential reporting) may be configured via control signaling (e.g., RRC signaling). For example, the UE 115-b may determine that the UE 115-b is to report a HARQ-ACK that does contain a differential channel quality report (e.g., a 2-bit HARQ-ACK) based on an RRC preconfiguration (e.g., that may be associated with a HARQ process identifier). Additionally, or alternatively, the UE 115-b may be preconfigured with one or more parameters for transmitting the differential measurement as described herein. For example, the UE 115-b may be configured to transmit the CSI report 310 with an absolute measurement of channel quality or signal strength and transmit the second HARQ-ACK 340 HARQ-ACK with a differential measurement of channel quality, and may do so without an indication of control signaling from the network entity 105-b.

In some examples, the UE 115-b may receive the third PDSCH 345. The third PDSCH 345 may be QCL'd with the second SSB 320 and may not be associated with the differential reporting (e.g., because it is QCL'd with a different SSB than the first PDSCH 325 and the second PDSCH 335 or because differential reporting was not configured or triggered by the network entity 105-b). As such, the UE 115-b may report the third HARQ-ACK 350 that may not contain or be associated with a differential signal quality report.

In some example, the UE 115-b may transmit the CSI report 355 that may reflect one or more changes in signal strength or quality of reference signals that may be QCL'd with the first SSB 315, the second SSB 320, or both. For example, the CSI report 355 may indicate that an RSRP of the first SSB 315 may have decreased (e.g., 5 dBm) and such a change may be the same or different than a change reported via the differential reporting made in associated with the second HARQ-ACK 340.

In some examples, the second HARQ-ACK 340 may include a differential measurement that is made relative to an earlier HARQ-ACK transmission that also carried an indication of channel quality (whether it be an absolute reference or another differential reference). For example, in some cases the first HARQ-ACK 330 may include a differential measurement or indication of channel quality made relative to a measurement or indication of channel quality provided in the CSI report 310 (e.g., associated with the first SSB 315). The UE 115-b may provide the second HARQ-ACK 340, which may carry yet another differential measurement that is made relative to the measurement provided in the first HARQ-ACK 330 (whether the measurement associated with the first HARQ-ACK 330 is differential or absolute).

As described herein, the UE 115-b may provide such differential reporting to the network entity 105-b to aid the network entity 105-b in beam prediction operations. In the example shown in FIG. 3, the RSRP associated with a received DMRS that itself is associated with the second PDSCH 335 is decreased measured relative to the signal strength of the first SSB 315 and the decrease was reported in the second HARQ-ACK 340. In this way, the network entity 105-b may be aware of such a change (e.g., due to the differential reporting) and may make one or more adjustments, additions, deletions, or any combination thereof to beam prediction operations based on the change. For example, the network entity 105-b may predict that a beam associated with the second SSB 320 may be stronger than or otherwise bear one or more characteristics as compared to a beam associated with the first SSB 315. In at least this way, beam prediction operations may be refined with the use of differential reporting schemes.

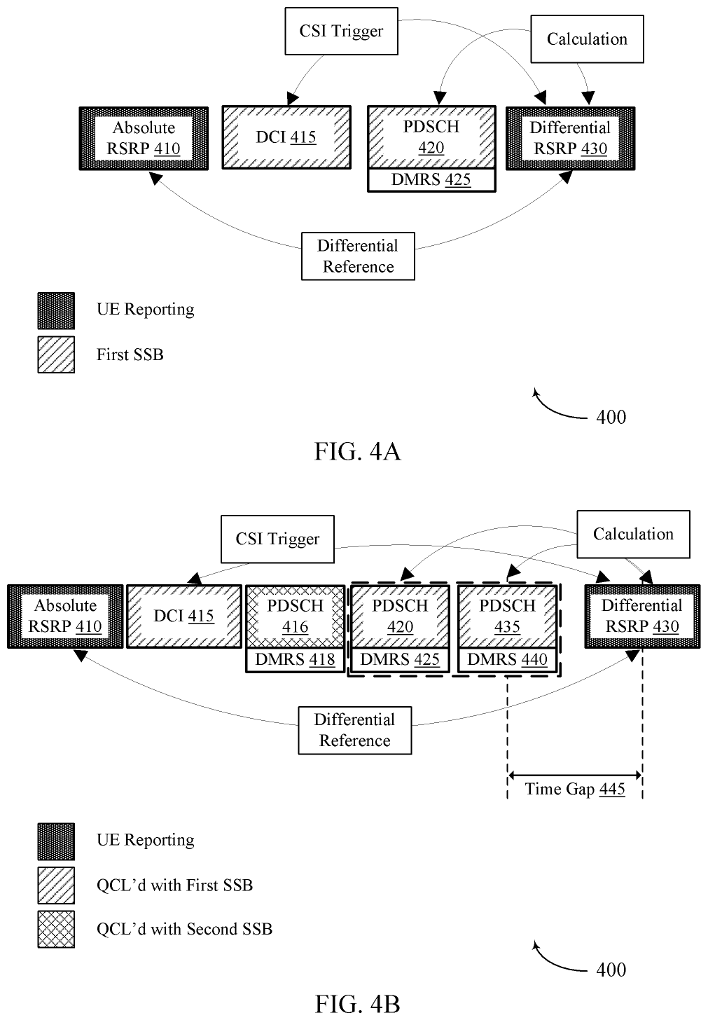

FIG. 4A illustrates an example of a differential channel quality reporting scheme 400 that supports differential demodulation reference signal based channel quality reporting in accordance with one or more aspects of the present disclosure. The differential channel quality reporting scheme 400 may employ CSI report-based triggering of differential reporting.

For example, a UE may be triggered in a DCI 415 (e.g., an uplink grant DCI or a downlink grant DCI) to prepare and transmit a CSI report (e.g., an aperiodic (AP) CSI report, optionally via a PUSCH) which may include a differential RSRP 430 of at least one differential indication of signal strength or quality (e.g., L1-RSRP, L1-SINR, CQI, other channel quality reporting, or any combination thereof) of the DMRS 425 associated with a PDSCH 420. The differential RSRP 430 may be based on or expressed relative to the absolute RSRP 410, which may be a last- or recently-reported RSRP (e.g., in a CSI report or other transmitted indication of channel quality, such as a HARQ-ACK report as described herein). In some examples, an AP-CSI triggering list may be employed in association with the DCI 415. In some such examples, a CSI triggering state may identify or select a CSI report setting that may allow or request such differential reporting (e.g., L1-RSRP, L1-SINR, CQI, other channel quality reporting, or any combination thereof) based on the DMRS 425 associated with the PDSCH 420.

In some examples, such CSI reports may be transmitted in CSI Part-1. Additionally, or alternatively, if 2 part CSI reporting is used, such CSI reports may be transmitted in CSI Part-2. Regardless of which CSI Part may be used to transmit the CSI reports, such a CSI report may have or indicate a priority that may be higher or lower than other CSI reports. For example, if a CSI report carrying a differential indication of channel quality is of a lower priority that other CSI reports, such a CSI report may be dropped (e.g., due to payload limitations). Additionally, or alternatively, a CSI report carrying a differential indication of channel quality may be of a higher priority than other CSI reports, in which case one or more other CSI reports may be dropped or postponed in favor of the CSI report carrying the differential indication of channel quality (e.g., due to payload limitations).

In some examples, the DCI 415 may include a downlink grant. In some such examples, a CSI report (e.g., that includes or indicates the differential RSRP 430) may be triggered in such a DCI 415, and the DMRS 425 associated with the PDSCH 420 may be scheduled by the DCI 415 that includes the downlink grant. In some examples, a UE may not expect that a reference signal (e.g., a type-D ACL source reference signal) of the DMRS 425 of the PDSCH 420 scheduled by such a DCI 415 (e.g., that includes a downlink grant) is not recently reported within a time window prior to receiving the DCI 415. For example, the UE may use a reference signal, such as the DMRS 425, that is received within such a time window for calculating the differential RSRP 430. The UE may, in some examples, not consider (e.g., for purposes of calculating the differential RSRP 430) another reference signal that is received outside of such a time window. In some examples, such a time window may be predefined (e.g., described in a relevant communications standard).

FIG. 4B illustrates another example of differential channel quality reporting scheme 400 that supports differential demodulation reference signal based channel quality reporting in accordance with one or more aspects of the present disclosure. In some examples, the DCI 415 may include an uplink grant. In some such examples, one or more PDSCH DMRSs may be included or considered for the calculation of the differential RSRP 430. For example, the DMRS 425 and the DMRS 435 may be selected for performing the calculation of the differential RSRP 430. In some examples, one or more indications of which DMRSs (e.g., DMRS 418 associated with PDSCH 416, DMRS 425 associated with PDSCH 420, DMRS 440 associated with PDSCH 435, or any combination thereof) are to be used for calculating the differential RSRP 430 may be based on received control signaling. Such control signaling may be RRC control signaling, optionally including an RRC config (e.g., associated with a CSI report setting of the triggered CSI report) in which the one or more indications may be included. For example, an aperiodic CSI report setting may specify that, if it is triggered, a reported RSRP or SINR (e.g., the differential RSRP 430) may be based on one or more PDSCH DMRSs that are to be QCL'd with an SSBRI. In such an example, the UE may average one or more received PDSCH DMRSs (e.g., DMRS 418, DMRS 425, DMRS 440, or any combination thereof) that are QCL'd with an SSBRI after receiving the UL grant DCI. Further, a selection of DMRSs may be further limited in that candidate DMRSs may be considered if they are received a quantity of symbols, slots, or time before transmitting the CSI report (e.g., that includes the differential RSRP 430). The time gap 445 may be an example of such a quantity of symbols, slots, or time. In some such examples, the quantity of symbols, slots, or time may be based on UE capability reporting, network entity configurations, other considerations, or any combination thereof. In some examples, the target source reference signal (e.g., an SSBRI) may be dynamically changed through the same UL grant DCI (e.g., through CSI triggering state enhancement).

In some examples, a UE may not expect that a reference signal (e.g., a type-D ACL source reference signal) of the DMRS 425 of the PDSCH 420 scheduled by such a DCI 415 (e.g., that includes an uplink grant) is not recently reported within a time window prior to receiving the DCI 415. For example, the UE may use a reference signal, such as the DMRS 425, that is received within such a time window for calculating the differential RSRP 430. The UE may, in some examples, not consider (e.g., for purposes of calculating the differential RSRP 430) another reference signal that is received outside of such a time window. In some examples, such a time window may be predefined (e.g., described in a relevant communications standard).

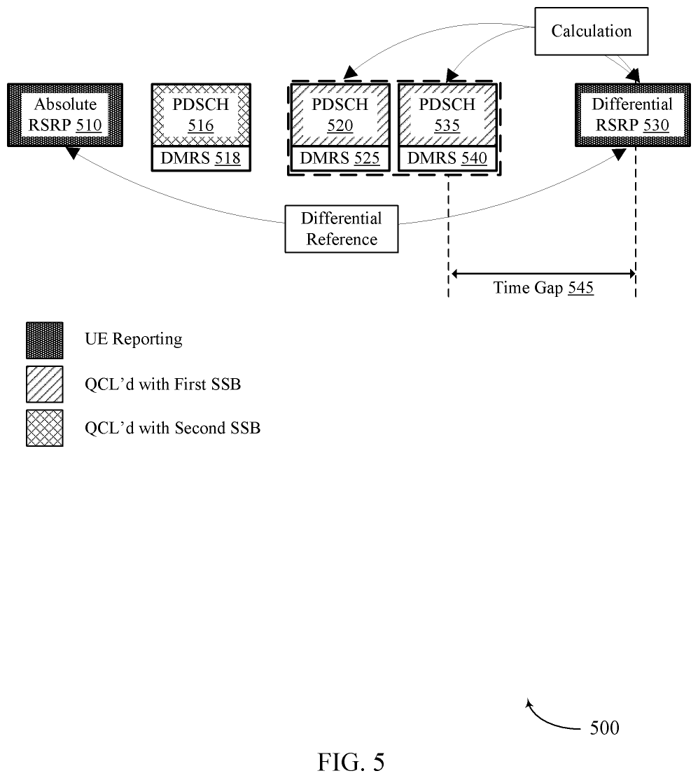

FIG. 5 illustrates an example of a differential channel quality reporting scheme 500 that supports differential demodulation reference signal based channel quality reporting in accordance with one or more aspects of the present disclosure. The differential channel quality reporting scheme 500 may be associated with persistent or semi-persistent (P/SP) CSI report-based approaches for reporting differential indications of channel quality.

In some examples, a UE may be configured (e.g., via RRC configuration) with a first P/SP CSI report setting that indicates that the UE is to differentially and periodically report one or more indications of channel quality (e.g., L1-RSRP, L1-SINR, CQI, other channel quality reporting, or any combination thereof) associated with at least one PDSCH DMRS (e.g., the DMRS 525 associated with the PDSCH 520, the DMRS 540 associated with PDSCH 535, or both) QCL'd with a source reference signal (e.g., an SSB, a CSI-RS, or both). In some examples, the differential report may be based on a recently reported indication of channel quality (e.g., L1-RSRP, L1-SINR, CQI, other channel quality reporting, or any combination thereof) that may be associated with the source reference signal (e.g., the absolute RSRP 510). In some examples, the other DMRSs (e.g., DMRS 518 associated with PDSCH 516) may not be included in the calculation of the differential reporting (e.g., the differential RSRP 530), since other DMRSs may be QCL'd with an SSB or CSI-RS (e.g., the second SSB) that is different than an SSB or CSI-RS associated with the absolute or reference measurement (e.g., the absolute RSRP 510). In some examples, the source reference signal may configured by the same CSI report setting that configures the UE to P/SP differential reporting or may be configured by a different CSI report setting. In some examples, the configuration for the source reference signal may be updated through control signaling (e.g., MAC-CE, DCI, RRC, or other control signaling).

In some examples, a first P/SP CSI report setting may be linked with a second P/SP CSI report setting. In some such cases, the UE may be configured to average measurements of some or all of the received DMRSs that are QCL'd with a source reference signal (e.g., DMRS 525 and DMRS 540), and may report such an average in a differential manner as described herein. In some cases, a UE may report a CSI report associated with the second P/SP CSI report setting, and may average measurements of DMRSs received after reporting the CSI report associated with the second P/SP CSI report setting and before a beginning of time gap 545. Time gap 545 may a quantity of symbols, slots, or time before transmitting the CSI report associated with the first P/SP CSI report setting. (e.g., that includes the differential RSRP 530). In some such examples, the quantity of symbols, slots, or time may be based on UE capability reporting, network entity configurations, other considerations, or any combination thereof. In some examples, the target source reference signal (e.g., an SSBRI) may be dynamically changed through the same UL grant DCI (e.g., through CSI triggering state enhancement).

In some examples, the CSI report associated with the second P/SP CSI report setting may include a source reference signal identifier (e.g., for an SSB, a CSI-RS, or other source reference signal) for an absolute indication of channel quality (e.g., L1-RSRP, L1-SINR, CQI, other channel quality reporting, or any combination thereof) such that the differential report of the CSI report associated with the first P/SP CSI report setting is based on or uses (e.g., as a reference) the recently reported absolute RSRP 510 or other absolute measurement (e.g., L1-RSRP, L1-SINR, CQI, other channel quality reporting, or any combination thereof) of the source reference signal.

In some examples of the subject matter described herein, a UE may report a differential measurement that may include a filtering report, an instantaneous report, or both. In some examples, a filtering report may be used to report one or more average or filtered RSRPs or SINRs. Such filtering or averaging may be applied to some or all of the DMRSs received after a 1st symbol and before a 2nd symbol, where the 1st symbol, the 2nd symbol, or both may be predefined, configured by one or more network entities, or both. For example, a first symbol may be predefined as a last symbol of a PUSCH transmission carrying the CSI report associated with another CSI report setting and the second symbol may be a quantity of symbols, slots, or time before a symbol, slot, or time position at which the next CSI report of the considered CSI report setting may be transmitted. In some such examples, the quantity of symbols, slots, or time may be predefined or configured (e.g., by a network entity).

Additionally, or alternatively, differential reporting may consider a single instance of a channel quality indication (e.g., an instantaneous report). In such approaches, if a PDSCH transmission is scheduled and is QCL'd with the configured source reference signal (e.g., an SSB or CSI-RS) within a time window after a first symbol and before a second symbol, the UE may report a single instance indication of channel quality (e.g., L1-RSRP, L1-SINR, CQI, other channel quality reporting, or any combination thereof) associated with the DMRS of the scheduled PDSCH. In some such examples, the first symbol, the second symbol, or both may be defined (e.g., by a short period between adjacent CSI reporting instances associated with a second P/SP CSI report setting, which may apply to examples of SSB or CSI-RS based channel quality reporting).

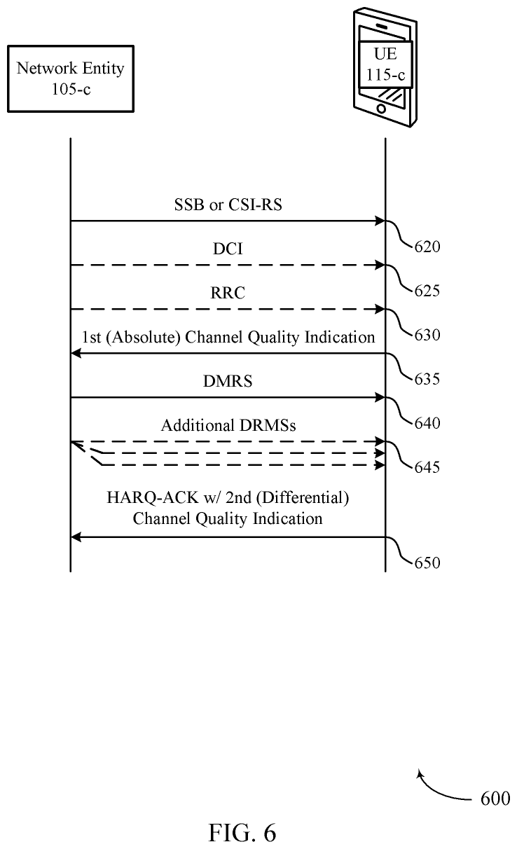

FIG. 6 illustrates an example of a process flow 600 that supports differential demodulation reference signal based channel quality reporting in accordance with one or more aspects of the present disclosure. The process flow 600 may implement various aspects of the present disclosure described with reference to FIGS. 1-5. The process flow 600 may include network entity 105-c and UE 115-c, which may be examples of similarly named elements as described with reference to FIGS. 1-5.

In the following description of the process flow 600, the operations between the network entity 105-c and UE 115-c may be performed in different orders or at different times. Some operations may also be left out of the process flow 600, or other operations may be added. Although the network entity 105-c and UE 115-c may be shown performing the operations of the process flow 600, some aspects of some operations may also be performed by other elements of the process flow 600 or by elements that are not depicted in the process flow, or any combination thereof.

At 620, the UE 115-c may receive a synchronization signal block or channel state information reference signal associated with a physical downlink shared channel.

At 625, the UE 115-c may receive downlink control information indicating that the UE is to provide differential reporting of channel quality associated with the physical downlink shared channel. In some examples, transmitting the hybrid automatic repeat request acknowledgment message may be based on receiving the downlink control information. In some examples, the downlink control information may include a field that indicates a quantity of bits for transmitting the hybrid automatic repeat request acknowledgment message.

At 630, the UE 115-c may receive radio resource control signaling associated with a hybrid automatic repeat request process identifier, the radio resource control signaling indicating that the UE is to provide differential reporting of channel quality associated with the physical downlink shared channel. In some examples, transmitting the hybrid automatic repeat request acknowledgment message may be based on receiving the radio resource control signaling. In some examples, the radio resource control signaling may indicate a quantity of bits for transmitting the hybrid automatic repeat request acknowledgment message.

At 635, the UE 115-c may transmit a first indication of channel quality of the physical downlink shared channel. In some examples, the first indication of channel quality of the physical downlink shared channel may be comprised in a channel state information report or a hybrid automatic repeat request acknowledgment message.

At 640, the UE 115-c may receive a demodulation reference signal that may be quasi co-located with the synchronization signal block or channel state information reference signal and associated with the physical downlink shared channel. In some examples, the demodulation reference signal may be received during a time window delineated by a beginning symbol and an end symbol.

At 645, the UE 115-c may receive one or more additional demodulation reference signals during an averaging time window defined by a beginning symbol and an end symbol, the one or more additional demodulation reference signals being quasi co-located with the synchronization signal block or channel state information reference signal and associated with the physical downlink shared channel. In some examples, the second indication of channel quality may be based on an average of a signal strength of the demodulation reference signal and signal strengths of at least one of the one or more additional demodulation reference signals.

At 650, the UE 115-c may transmit a hybrid automatic repeat request acknowledgment message that may include a second indication of channel quality of the physical downlink shared channel based on the demodulation reference signal, and the second indication of channel quality may include a differential measurement that is relative to the first indication of channel quality. In some examples, transmitting the hybrid automatic repeat request acknowledgment message may include transmitting a multi-bit field that may include a first bit that indicates a positive acknowledgment or a negative acknowledgment and a second bit that indicates the differential measurement. In some examples, the second bit of the multi-bit field may indicate that a signal strength of the demodulation reference signal is higher than, lower than, or equal to a signal strength associated with the first indication of channel quality. In some examples, the second bit of the multi-bit field may indicate that a signal strength of the demodulation reference signal differs from a signal strength associated with the first indication of channel quality by a value that is less than, equal to, or greater than a threshold value. In some examples, the first indication of channel quality, the second indication of channel quality, or both, comprise a layer one reference signal received power, a layer one signal to interference and noise ratio, a channel quality indicator, or any combination thereof.

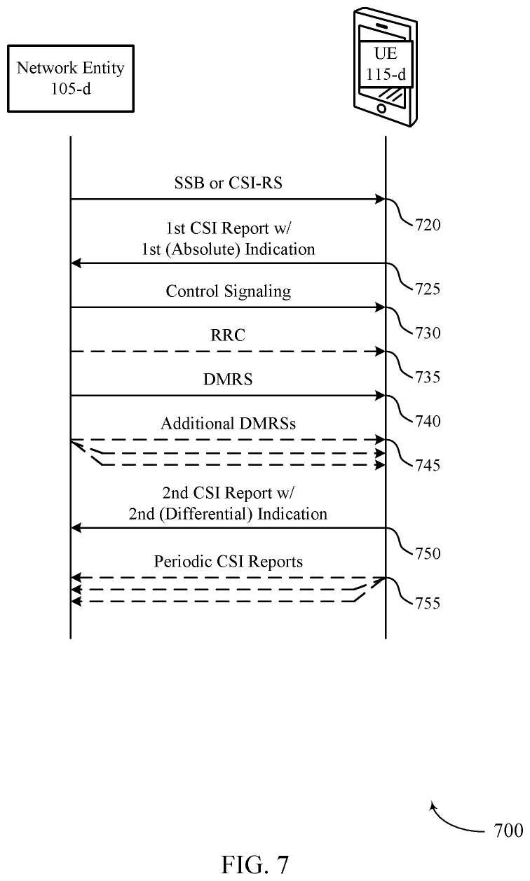

FIG. 7 illustrates an example of a process flow 700 that supports differential demodulation reference signal based channel quality reporting in accordance with one or more aspects of the present disclosure. The process flow 700 may implement various aspects of the present disclosure described with reference to FIGS. 1-6. The process flow 700 may include network entity 105-d and UE 115-d, which may be examples of similarly named elements as described with reference to FIGS. 1-6.

In the following description of the process flow 700, the operations between the network entity 105-d and UE 115-d may be performed in different orders or at different times. Some operations may also be left out of the process flow 700, or other operations may be added. Although the network entity 105-d and UE 115-d are shown performing the operations of the process flow 700, some aspects of some operations may also be performed by other elements of the process flow 700 or by elements that are not depicted in the process flow, or any combination thereof.

At 720, the UE 115-d may receive a synchronization signal block or channel state information reference signal associated with a physical downlink shared channel.

At 725, the UE 115-d may transmit a first indication of channel quality of the physical downlink shared channel in a first channel state information report.

At 730, the UE 115-d may receive control signaling that may indicate that the UE is to provide differential reporting of channel state information associated with the physical downlink shared channel. In some examples, the UE 115-d may receive receiving the control signaling that may include a downlink grant for a downlink transmission and the demodulation reference signal may be associated with the downlink transmission. In some examples, the UE 115-d may receive the control signaling that may include an uplink grant. In some examples, the UE 115-d may receive the control signaling within a predefined time period after receiving the demodulation reference signal.

At 735, the UE 115-d may receive radio resource control signaling that may indicate a channel state information report configuration that indicates one or more demodulation reference signals that may be quasi co-located with the synchronization signal block channel state information reference signal. Additionally, or alternatively, the UE 115-d may receive radio resource control signaling that may include a channel state information report configuration indicating that the UE is to provide periodic channel state information reports that may include differential reporting of channel state information associated with the physical downlink shared channel. In some examples, the channel state information report configuration may indicate that the differential measurement is to be made relative to the first indication of channel quality.

At 740, the UE 115-d may receive a demodulation reference signal that may be quasi co-located with the synchronization signal block or channel state information reference signal and associated with the physical downlink shared channel. In some examples, the demodulation reference signal may be received during a time window delineated by a beginning symbol and an end symbol.

At 745, the UE 115-d may receive one or more additional demodulation reference signals during an averaging time window delineated by a beginning symbol and an end symbol, the one or more additional demodulation reference signals that may be quasi co-located with the synchronization signal block or channel state information reference signal and associated with the physical downlink shared channel and the second indication of channel quality may be based on an average of a signal strength of the demodulation reference signal and signal strengths of at least one of the one or more additional demodulation reference signals.

At 750, the UE 115-d may transmit a second channel state information report that may include a second indication of channel quality of the physical downlink shared channel based on the demodulation reference signal and receiving the control signaling, and the second indication of channel quality of the physical downlink shared channel may include a differential measurement that may be relative to the first indication of channel quality. In some examples, the second indication of channel quality may be based on the indicated one or more demodulation reference signals. In some examples, the UE 115-d may transmit the second channel state information report via a second part of a two-part channel state information report. In some examples, the UE 115-d may transmit the second channel state information report and the second indication of channel quality may be based on an average of a signal strength of the demodulation reference signal and signal strengths of one or more additional demodulation reference signals that may be quasi co-located with the synchronization signal block or channel state information reference signal and received after a most-recently transmitted previous channel state information report and before a time buffer that precedes transmitting the second channel state information report. In some examples, the first indication of channel quality, the second indication of channel quality, or both, comprise a layer one reference signal received power, a layer one signal to interference and noise ratio, a channel quality indicator, or any combination thereof.

At 755, the UE 115-d may transmit the periodic channel state information reports based on receiving the radio resource control signaling, each periodic channel state information report that may include an indication of channel quality of the physical downlink shared channel based on a last-received demodulation reference signal.

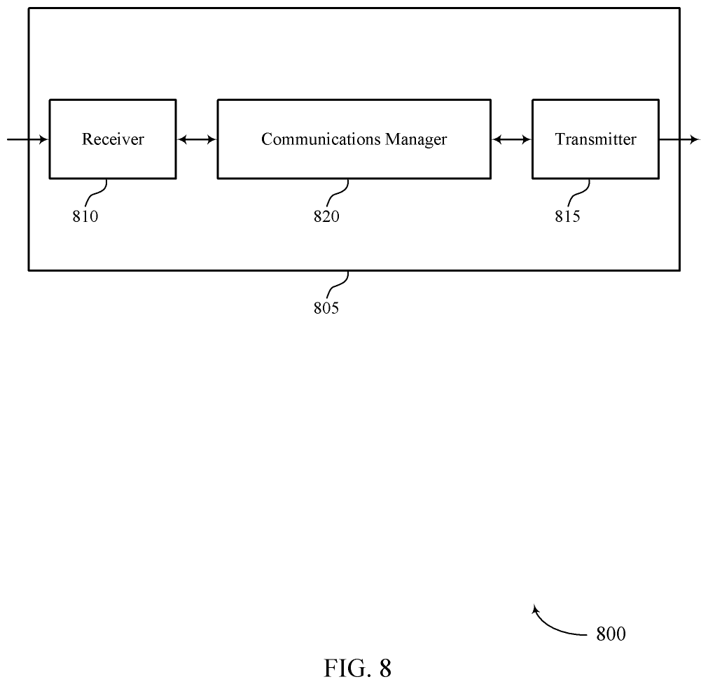

FIG. 8 shows a block diagram 800 of a device 805 that supports differential demodulation reference signal based channel quality reporting in accordance with one or more aspects of the present disclosure. The device 805 may be an example of aspects of a UE 115 as described herein. The device 805 may include a receiver 810, a transmitter 815, and a communications manager 820. The device 805 may also include one or more processors, memory coupled with the one or more processors, and instructions stored in the memory that are executable by the one or more processors to enable the one or more processors to perform the differential reporting features discussed herein. Each of these components may be in communication with one another (e.g., via one or more buses).

The receiver 810 may provide a means for receiving information such as packets, user data, control information, or any combination thereof associated with various information channels (e.g., control channels, data channels, information channels related to differential demodulation reference signal based channel quality reporting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to differential demodulation reference signal based channel quality reporting). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of differential demodulation reference signal based channel quality reporting as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

Additionally, or alternatively, the communications manager 820 may support wireless communications at a UE in accordance with examples as disclosed herein. For example, the communications manager 820 may be configured as or otherwise support a means for receiving a synchronization signal block or channel state information reference signal. The communications manager 820 may be configured as or otherwise support a means for transmitting a channel state information report including a first indication of channel quality associated with the synchronization signal block or channel state information reference signal. The communications manager 820 may be configured as or otherwise support a means for receiving a demodulation reference signal that is quasi co-located with the synchronization signal block or channel state information reference signal and associated with a physical downlink shared channel. The communications manager 820 may be configured as or otherwise support a means for transmitting a hybrid automatic repeat request acknowledgment message including a second indication of channel quality associated with the demodulation reference signal of the physical downlink shared channel, where the second indication of channel quality includes a differential measurement that is relative to the first indication of channel quality.

Additionally, or alternatively, the communications manager 820 may support wireless communications at a UE in accordance with examples as disclosed herein. For example, the communications manager 820 may be configured as or otherwise support a means for receiving a synchronization signal block or channel state information reference signal. The communications manager 820 may be configured as or otherwise support a means for transmitting a channel state information report including a first indication of channel quality. The communications manager 820 may be configured as or otherwise support a means for receiving control signaling indicating that the UE is to provide differential reporting of channel quality based on at least one demodulation reference signal associated with a physical downlink shared channel. The communications manager 820 may be configured as or otherwise support a means for receiving the demodulation reference signal that is quasi co-located with the synchronization signal block or channel state information reference signal and associated with the physical downlink shared channel. The communications manager 820 may be configured as or otherwise support a means for transmitting a second channel state information report including a second indication of channel quality associated with the demodulation reference signal of the physical downlink shared channel based on receiving the control signaling, where the second indication of channel quality includes a differential measurement that is relative to the first indication of channel quality.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, reduced power consumption, more efficient utilization of communication resources, or any combination thereof.

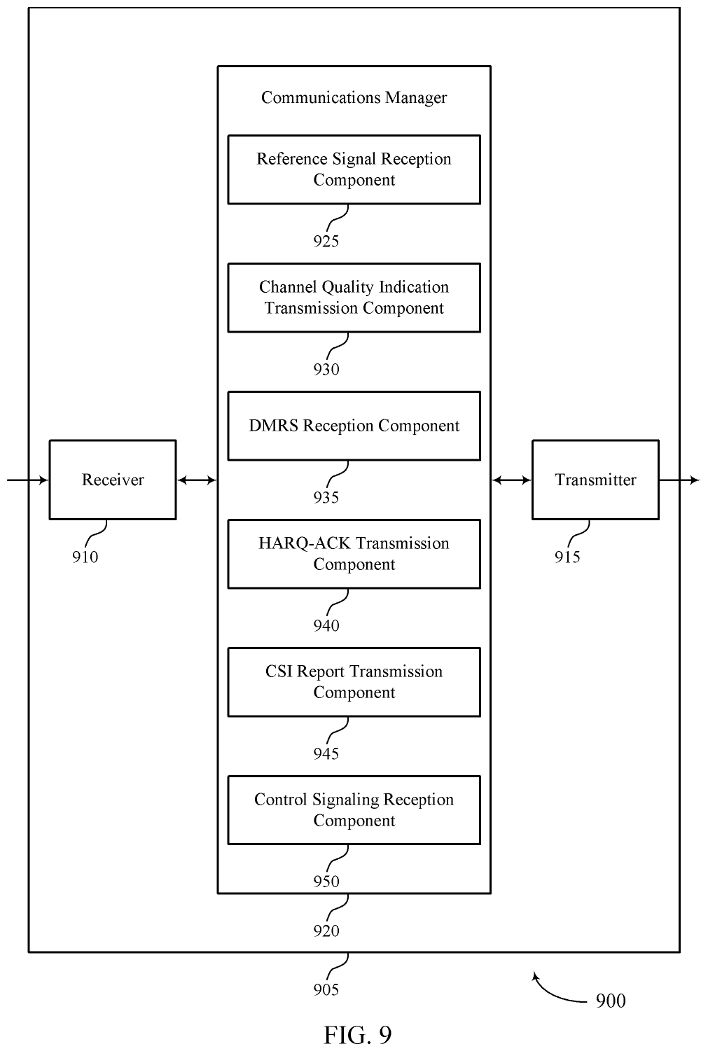

FIG. 9 shows a block diagram 900 of a device 905 that supports differential demodulation reference signal based channel quality reporting in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to differential demodulation reference signal based channel quality reporting). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to differential demodulation reference signal based channel quality reporting). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of differential demodulation reference signal based channel quality reporting as described herein. For example, the communications manager 920 may include a reference signal reception component 925, a channel quality indication transmission component 930, a DMRS reception component 935, an HARQ-ACK transmission component 940, a CSI report transmission component 945, a control signaling reception component 950, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. The reference signal reception component 925 may be configured as or otherwise support a means for receiving a synchronization signal block or channel state information reference signal. The channel quality indication transmission component 930 may be configured as or otherwise support a means for transmitting a channel state information report including a first indication of channel quality associated with the synchronization signal block or channel state information reference signal. The DMRS reception component 935 may be configured as or otherwise support a means for receiving a demodulation reference signal that is quasi co-located with the synchronization signal block or channel state information reference signal and associated with a physical downlink shared channel. The HARQ-ACK transmission component 940 may be configured as or otherwise support a means for transmitting a hybrid automatic repeat request acknowledgment message including a second indication of channel quality associated with the demodulation reference signal of the physical downlink shared channel, where the second indication of channel quality includes a differential measurement that is relative to the first indication of channel quality.

Additionally, or alternatively, the communications manager 920 may support wireless communications at a UE in accordance with examples as disclosed herein. The reference signal reception component 925 may be configured as or otherwise support a means for receiving a synchronization signal block or channel state information reference signal. The CSI report transmission component 945 may be configured as or otherwise support a means for transmitting a channel state information report including a first indication of channel quality. The control signaling reception component 950 may be configured as or otherwise support a means for receiving control signaling indicating that the UE is to provide differential reporting of channel quality based on at least one demodulation reference signal associated with a physical downlink shared channel. The DMRS reception component 935 may be configured as or otherwise support a means for receiving the demodulation reference signal that is quasi co-located with the synchronization signal block or channel state information reference signal and associated with the physical downlink shared channel. The CSI report transmission component 945 may be configured as or otherwise support a means for transmitting a second channel state information report including a second indication of channel quality associated with the demodulation reference signal of the physical downlink shared channel based on receiving the control signaling, where the second indication of channel quality includes a differential measurement that is relative to the first indication of channel quality.

“In some cases, the reference signal reception component 925, the channel quality indication transmission component 930, the DRMS reception component 935, the HARQ-ACK transmission component 940, the CSI report transmission component 945, and the control signaling reception component 950 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the reference signal reception component 925, the channel quality indication transmission component 930, the DRMS reception component 935, the HARQ-ACK transmission component 940, the CSI report transmission component 945, and the control signaling reception component 950 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.”

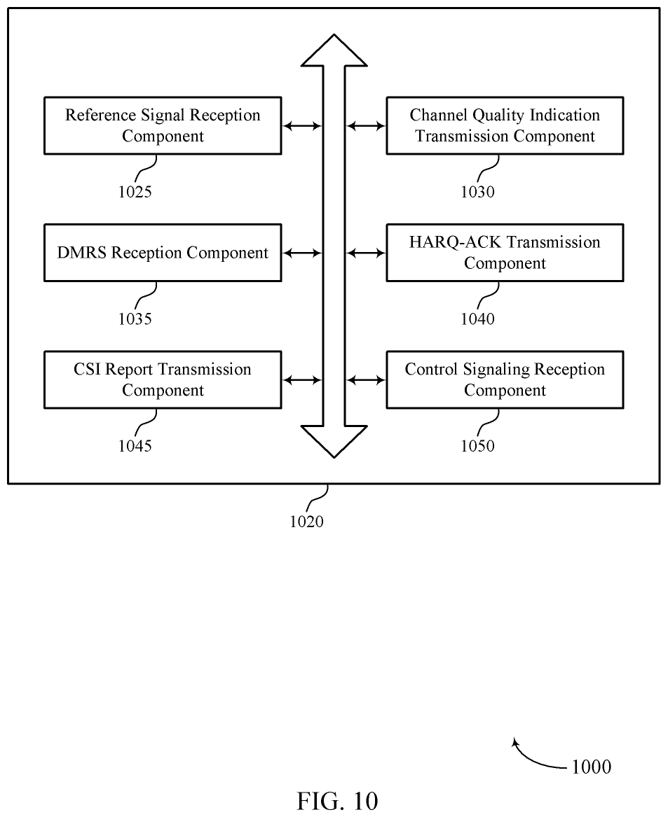

FIG. 10 shows a block diagram 1000 of a communications manager 1020 that supports differential demodulation reference signal based channel quality reporting in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of differential demodulation reference signal based channel quality reporting as described herein. For example, the communications manager 1020 may include a reference signal reception component 1025, a channel quality indication transmission component 1030, a DMRS reception component 1035, an HARQ-ACK transmission component 1040, a CSI report transmission component 1045, a control signaling reception component 1050, or any combination thereof. Each of these components may communicate, directly or indirectly, with one another (e.g., via one or more buses).

Additionally, or alternatively, the communications manager 1020 may support wireless communications at a UE in accordance with examples as disclosed herein. The reference signal reception component 1025 may be configured as or otherwise support a means for receiving a synchronization signal block or channel state information reference signal. The channel quality indication transmission component 1030 may be configured as or otherwise support a means for transmitting a channel state information report including a first indication of channel quality associated with the synchronization signal block or channel state information reference signal. The DMRS reception component 1035 may be configured as or otherwise support a means for receiving a demodulation reference signal that is quasi co-located with the synchronization signal block or channel state information reference signal and associated with a physical downlink shared channel. The HARQ-ACK transmission component 1040 may be configured as or otherwise support a means for transmitting a hybrid automatic repeat request acknowledgment message including a second indication of channel quality associated with the demodulation reference signal of the physical downlink shared channel, where the second indication of channel quality includes a differential measurement that is relative to the first indication of channel quality.

In some examples, the control signaling reception component 1050 may be configured as or otherwise support a means for receiving downlink control information indicating that the UE is to provide differential reporting of channel quality associated with the physical downlink shared channel, where transmitting the hybrid automatic repeat request acknowledgment message is based on receiving the downlink control information.

In some examples, the downlink control information includes a field that indicates a quantity of bits for transmitting the hybrid automatic repeat request acknowledgement message.

In some examples, the control signaling reception component 1050 may be configured as or otherwise support a means for receiving radio resource control signaling associated with a hybrid automatic repeat request process identifier, the radio resource control signaling indicating that the UE is to provide differential reporting of channel quality associated with the physical downlink shared channel, where transmitting the hybrid automatic repeat request acknowledgement message is based on receiving the radio resource control signaling.

In some examples, the radio resource control signaling indicates a quantity of bits for transmitting the hybrid automatic repeat request acknowledgement message.

In some examples, to support transmitting the hybrid automatic repeat request acknowledgement message, the HARQ-ACK transmission component 1040 may be configured as or otherwise support a means for transmitting a multi-bit field including a first bit that indicates a positive acknowledgement or a negative acknowledgement and a second bit that indicates the differential measurement.

In some examples, the second bit of the multi-bit field indicates that a signal strength of the demodulation reference signal is higher than, lower than, or equal to a signal strength associated with the first indication of channel quality.

In some examples, the second bit of the multi-bit field indicates that a signal strength of the demodulation reference signal differs from a signal strength associated with the first indication of channel quality by a value that is less than, equal to, or greater than a threshold value.

In some examples, the DMRS reception component 1035 may be configured as or otherwise support a means for receiving one or more additional demodulation reference signals during an averaging time window defined by a beginning symbol and an end symbol, the one or more additional demodulation reference signals being quasi co-located with the synchronization signal block or channel state information reference signal and associated with the same or another physical downlink shared channel, where the second indication of channel quality is based on an average of a signal strength of the demodulation reference signal and signal strengths of at least one of the one or more additional demodulation reference signals.

In some examples, the demodulation reference signal is received during a time window delineated by a beginning symbol and an end symbol.

In some examples, the DMRS reception component 1035 may be configured as or otherwise support a means for receiving a second demodulation reference signal that is quasi co-located with the synchronization signal block or channel state information reference signal and associated with the physical downlink shared channel. In some examples, the HARQ-ACK transmission component 1040 may be configured as or otherwise support a means for transmitting a second hybrid automatic repeat request acknowledgment message including a third indication of channel quality associated with the second demodulation reference signal of the physical downlink shared channel, where the third indication of channel quality includes a differential measurement that is relative to the second indication of channel quality or the first indication of channel quality.

In some examples, the DMRS reception component 1035 may be configured as or otherwise support a means for receiving a third demodulation reference signal that is quasi co-located with the synchronization signal block or channel state information reference signal and associated with the physical downlink shared channel. In some examples, the HARQ-ACK transmission component 1040 may be configured as or otherwise support a means for transmitting a third hybrid automatic repeat request acknowledgment message including a fourth indication of channel quality associated with the third demodulation reference signal of the physical downlink shared channel, where the fourth indication of channel quality includes a differential measurement that is relative to the third indication of channel quality, the second indication of channel quality, or the first indication of channel quality.

In some examples, the first indication of channel quality, the second indication of channel quality, or both, include a layer one reference signal received power, a layer one signal to interference and noise ratio, a channel quality indicator, or any combination thereof.

Additionally, or alternatively, the communications manager 1020 may support wireless communications at a UE in accordance with examples as disclosed herein. In some examples, the reference signal reception component 1025 may be configured as or otherwise support a means for receiving a synchronization signal block or channel state information reference signal. The CSI report transmission component 1045 may be configured as or otherwise support a means for transmitting a channel state information report including a first indication of channel quality. The control signaling reception component 1050 may be configured as or otherwise support a means for receiving control signaling indicating that the UE is to provide differential reporting of channel quality based on at least one demodulation reference signal associated with a physical downlink shared channel. In some examples, the DMRS reception component 1035 may be configured as or otherwise support a means for receiving the demodulation reference signal that is quasi co-located with the synchronization signal block or channel state information reference signal and associated with the physical downlink shared channel. In some examples, the CSI report transmission component 1045 may be configured as or otherwise support a means for transmitting a second channel state information report including a second indication of channel quality associated with the demodulation reference signal of the physical downlink shared channel based on receiving the control signaling, where the second indication of channel quality includes a differential measurement that is relative to the first indication of channel quality.

In some examples, the control signaling reception component 1050 may be configured as or otherwise support a means for receiving the control signaling including a downlink grant for a downlink transmission, where the demodulation reference signal is associated with the downlink transmission.

In some examples, the control signaling reception component 1050 may be configured as or otherwise support a means for receiving the control signaling including an uplink grant. In some examples, the control signaling reception component 1050 may be configured as or otherwise support a means for receiving radio resource control signaling indicating a channel state information report configuration that indicates one or more demodulation reference signals upon which the second indication of channel quality is to be based, where the one or more demodulation reference signals are only quasi co-located with the synchronization signal block or channel state information reference signal. In some examples, the CSI report transmission component 1045 may be configured as or otherwise support a means for where the second indication of channel quality is based on the indicated one or more demodulation reference signals and the synchronization signal block or channel state information reference signal.

In some examples, the control signaling reception component 1050 may be configured as or otherwise support a means for receiving the control signaling including an uplink grant and an indication that the UE is to provide the differential reporting of channel based on the synchronization signal block or channel state information reference signal.

In some examples, the DMRS reception component 1035 may be configured as or otherwise support a means for receiving the demodulation reference signal during a time period that occurs before receiving the control signaling.

In some examples, the CSI report transmission component 1045 may be configured as or otherwise support a means for transmitting the second channel state information report via a second part of a two-part channel state information report.

In some examples, the control signaling reception component 1050 may be configured as or otherwise support a means for receiving radio resource control signaling including a channel state information report configuration indicating that the UE is to provide periodic channel state information reports including differential reporting of channel state information associated with the physical downlink shared channel. In some examples, the CSI report transmission component 1045 may be configured as or otherwise support a means for transmitting the periodic channel state information reports based on receiving the radio resource control signaling, each periodic channel state information report including an indication of channel quality of the physical downlink shared channel based on a last-received demodulation reference signal.

In some examples, the control signaling reception component 1050 may be configured as or otherwise support a means for where the channel state information report configuration indicates that the differential measurement is to be made relative to the first indication of channel quality.

In some examples, the CSI report transmission component 1045 may be configured as or otherwise support a means for transmitting the second channel state information report, where the second indication of channel quality is based on an average of a signal strength of the demodulation reference signal and signal strengths of one or more additional demodulation reference signals that are quasi co-located with the synchronization signal block or channel state information reference signal and received after a most-recently transmitted previous channel state information report and before a time buffer that precedes transmitting the second channel state information report.

In some examples, the DMRS reception component 1035 may be configured as or otherwise support a means for receiving one or more additional demodulation reference signals during an averaging time window delineated by a beginning symbol and an end symbol, the one or more additional demodulation reference signals that are quasi co-located with the synchronization signal block or channel state information reference signal and associated with the same or additional physical downlink shared channel, where the second indication of channel quality is based on an average of a signal strength of the demodulation reference signal and signal strengths of at least one of the one or more additional demodulation reference signals.

In some examples, the DMRS reception component 1035 may be configured as or otherwise support a means for where the demodulation reference signal is received during a time window delineated by a beginning symbol and an end symbol.

In some examples, the first indication of channel quality, the second indication of channel quality, or both, include a layer one reference signal received power, a layer one signal to interference and noise ratio, a channel quality indicator, or any combination thereof.

In some cases, the reference signal reception component 1025, the channel quality indication transmission component 1030, the DRMS reception component 1035, the HARQ-ACK transmission component 1040, the CSI report transmission component 1045, and the control signaling reception component 1050 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the reference signal reception component 1025, the channel quality indication transmission component 1030, the DRMS reception component 1035, the HARQ-ACK transmission component 1040, the CSI report transmission component 1045, and the control signaling reception component 1050 discussed herein.

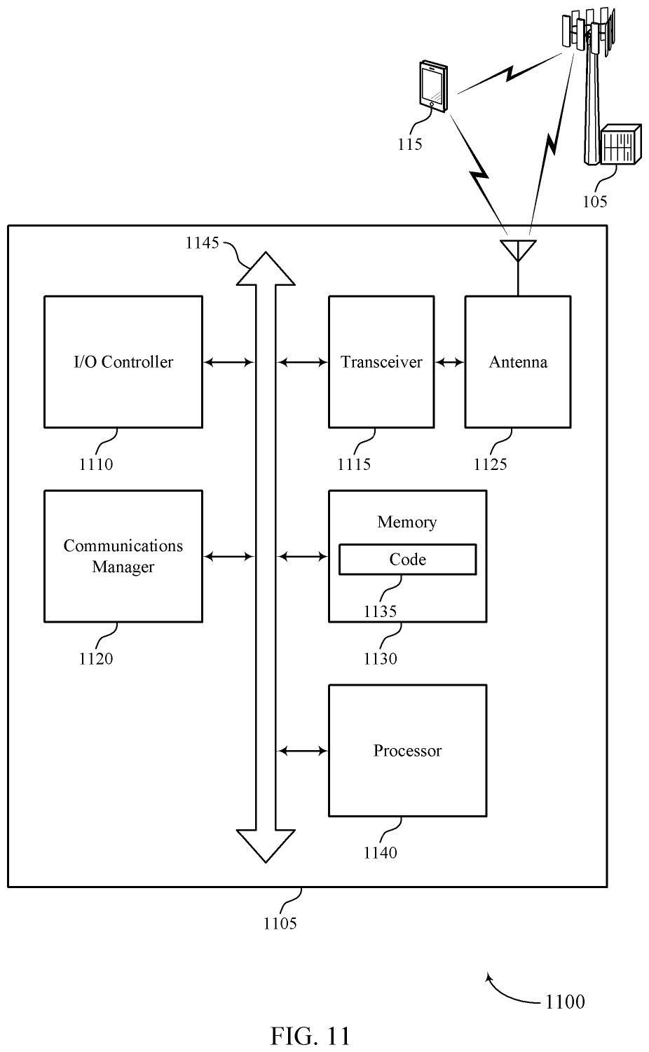

FIG. 11 shows a diagram of a system 1100 including a device 1105 that supports differential demodulation reference signal based channel quality reporting in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting differential demodulation reference signal based channel quality reporting). For example, the device 1105 or a component of the device 1105 may include a processor 1140 and memory 1130 coupled with or to the processor 1140, the processor 1140 and memory 1130 configured to perform various functions described herein.

Additionally, or alternatively, the communications manager 1120 may support wireless communications at a UE in accordance with examples as disclosed herein. For example, the communications manager 1120 may be configured as or otherwise support a means for receiving a synchronization signal block or channel state information reference signal. The communications manager 1120 may be configured as or otherwise support a means for transmitting a channel state information report including a first indication of channel quality associated with the synchronization signal block or channel state information reference signal. The communications manager 1120 may be configured as or otherwise support a means for receiving a demodulation reference signal that is quasi co-located with the synchronization signal block or channel state information reference signal and associated with a physical downlink shared channel. The communications manager 1120 may be configured as or otherwise support a means for transmitting a hybrid automatic repeat request acknowledgment message including a second indication of channel quality associated with the demodulation reference signal of the physical downlink shared channel, where the second indication of channel quality includes a differential measurement that is relative to the first indication of channel quality.

Additionally, or alternatively, the communications manager 1120 may support wireless communications at a UE in accordance with examples as disclosed herein. For example, the communications manager 1120 may be configured as or otherwise support a means for receiving a synchronization signal block or channel state information reference signal. The communications manager 1120 may be configured as or otherwise support a means for transmitting a channel state information report including a first indication of channel quality. The communications manager 1120 may be configured as or otherwise support a means for receiving control signaling indicating that the UE is to provide differential reporting of channel quality based on at least one demodulation reference signal associated with a physical downlink shared channel. The communications manager 1120 may be configured as or otherwise support a means for receiving the demodulation reference signal that is quasi co-located with the synchronization signal block or channel state information reference signal and associated with the physical downlink shared channel. The communications manager 1120 may be configured as or otherwise support a means for transmitting a second channel state information report including a second indication of channel quality associated with the demodulation reference signal of the physical downlink shared channel based on receiving the control signaling, where the second indication of channel quality includes a differential measurement that is relative to the first indication of channel quality.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of differential demodulation reference signal based channel quality reporting as described herein, or the processor 1140 and the memory 1130 may be otherwise configured to perform or support such operations.

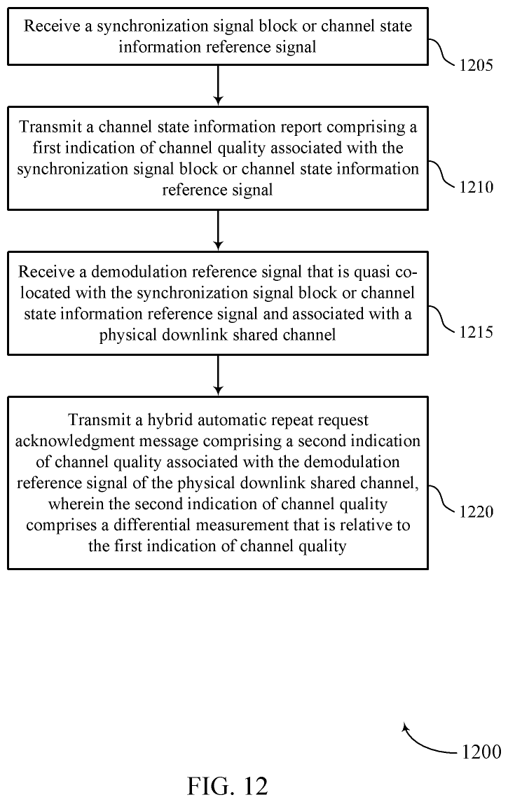

FIG. 12 shows a flowchart illustrating a method 1200 that supports differential demodulation reference signal based channel quality reporting in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving a synchronization signal block or channel state information reference signal. The operations of 1205 may be performed in accordance with examples as disclosed herein. In some examples, aspects of the operations of 1205 may be performed by a reference signal reception component 1025 as described with reference to FIG. 10.

At 1210, the method may include transmitting a channel state information report including a first indication of channel quality associated with the synchronization signal block or channel state information reference signal. The operations of 1210 may be performed in accordance with examples as disclosed herein. In some examples, aspects of the operations of 1210 may be performed by a channel quality indication transmission component 1030 as described with reference to FIG. 10.

At 1215, the method may include receiving a demodulation reference signal that is quasi co-located with the synchronization signal block or channel state information reference signal and associated with a physical downlink shared channel. The operations of 1215 may be performed in accordance with examples as disclosed herein. In some examples, aspects of the operations of 1215 may be performed by a DMRS reception component 1035 as described with reference to FIG. 10.

At 1220, the method may include transmitting a hybrid automatic repeat request acknowledgment message including a second indication of channel quality associated with the demodulation reference signal of the physical downlink shared channel, where the second indication of channel quality includes a differential measurement that is relative to the first indication of channel quality. The operations of 1220 may be performed in accordance with examples as disclosed herein. In some examples, aspects of the operations of 1220 may be performed by an HARQ-ACK transmission component 1040 as described with reference to FIG. 10.

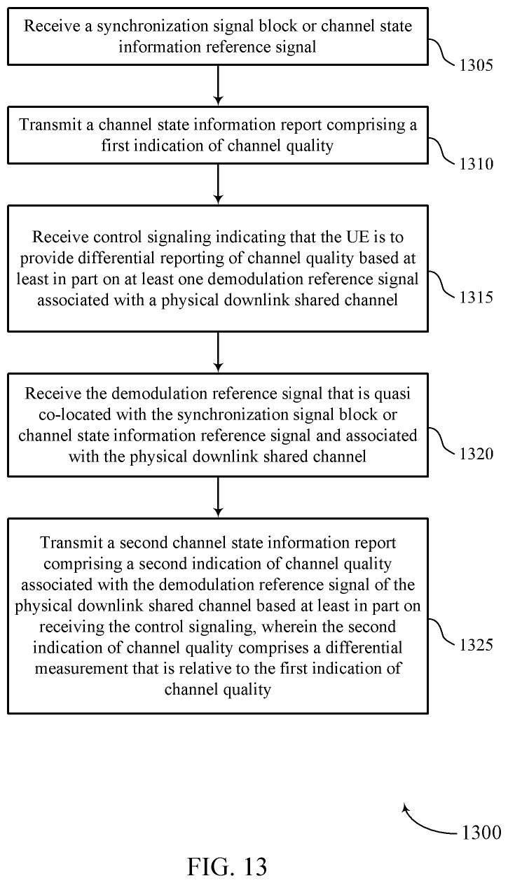

FIG. 13 shows a flowchart illustrating a method 1300 that supports differential demodulation reference signal based channel quality reporting in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving a synchronization signal block or channel state information reference signal. The operations of 1305 may be performed in accordance with examples as disclosed herein. In some examples, aspects of the operations of 1305 may be performed by a reference signal reception component 1025 as described with reference to FIG. 10.

At 1310, the method may include transmitting a channel state information report including a first indication of channel quality. The operations of 1310 may be performed in accordance with examples as disclosed herein. In some examples, aspects of the operations of 1310 may be performed by a CSI report transmission component 1045 as described with reference to FIG. 10.

At 1315, the method may include receiving control signaling indicating that the UE is to provide differential reporting of channel quality based on at least one demodulation reference signal associated with a physical downlink shared channel. The operations of 1315 may be performed in accordance with examples as disclosed herein. In some examples, aspects of the operations of 1315 may be performed by a control signaling reception component 1050 as described with reference to FIG. 10.

At 1320, the method may include receiving the demodulation reference signal that is quasi co-located with the synchronization signal block or channel state information reference signal and associated with the physical downlink shared channel. The operations of 1320 may be performed in accordance with examples as disclosed herein. In some examples, aspects of the operations of 1320 may be performed by a DMRS reception component 1035 as described with reference to FIG. 10.

At 1325, the method may include transmitting a second channel state information report including a second indication of channel quality associated with the demodulation reference signal of the physical downlink shared channel based on receiving the control signaling, where the second indication of channel quality includes a differential measurement that is relative to the first indication of channel quality. The operations of 1325 may be performed in accordance with examples as disclosed herein. In some examples, aspects of the operations of 1325 may be performed by a CSI report transmission component 1045 as described with reference to FIG. 10.

The following provides an overview of aspects of the present disclosure:

Aspect 1: A method for wireless communications at a UE, comprising: receiving a synchronization signal block or channel state information reference signal; transmitting a channel state information report comprising a first indication of channel quality associated with the synchronization signal block or channel state information reference signal; receiving a demodulation reference signal that is quasi co-located with the synchronization signal block or channel state information reference signal and associated with a physical downlink shared channel; and transmitting a hybrid automatic repeat request acknowledgment message comprising a second indication of channel quality associated with the demodulation reference signal of the physical downlink shared channel, wherein the second indication of channel quality comprises a differential measurement that is relative to the first indication of channel quality.

Aspect 2: The method of aspect 1, further comprising: receiving downlink control information indicating that the UE is to provide differential reporting of channel quality associated with the physical downlink shared channel, wherein transmitting the hybrid automatic repeat request acknowledgment message is based at least in part on receiving the downlink control information.

Aspect 3: The method of aspect 2, wherein the downlink control information comprises a field that indicates a quantity of bits for transmitting the hybrid automatic repeat request acknowledgement message.

Aspect 4: The method of any of aspects 1 through 3, further comprising: receiving radio resource control signaling associated with a hybrid automatic repeat request process identifier, the radio resource control signaling indicating that the UE is to provide differential reporting of channel quality associated with the physical downlink shared channel, wherein transmitting the hybrid automatic repeat request acknowledgement message is based at least in part on receiving the radio resource control signaling.

Aspect 5: The method of aspect 4, wherein the radio resource control signaling indicates a quantity of bits for transmitting the hybrid automatic repeat request acknowledgement message.

Aspect 6: The method of any of aspects 1 through 5, wherein transmitting the hybrid automatic repeat request acknowledgement message comprises: transmitting a multi-bit field comprising a first bit that indicates a positive acknowledgement or a negative acknowledgement and a second bit that indicates the differential measurement.

Aspect 7: The method of aspect 6, wherein the second bit of the multi-bit field indicates that a signal strength of the demodulation reference signal is higher than, lower than, or equal to a signal strength associated with the first indication of channel quality.

Aspect 8: The method of any of aspects 6 through 7, wherein the second bit of the multi-bit field indicates that a signal strength of the demodulation reference signal differs from a signal strength associated with the first indication of channel quality by a value that is less than, equal to, or greater than a threshold value.

Aspect 9: The method of any of aspects 1 through 8, further comprising: receiving one or more additional demodulation reference signals during an averaging time window defined by a beginning symbol and an end symbol, the one or more additional demodulation reference signals being quasi co-located with the synchronization signal block or channel state information reference signal and associated with the same or another physical downlink shared channel, wherein the second indication of channel quality is based at least in part on an average of a signal strength of the demodulation reference signal and signal strengths of at least one of the one or more additional demodulation reference signals.

Aspect 10: The method of any of aspects 1 through 9, wherein the demodulation reference signal is received during a time window delineated by a beginning symbol and an end symbol.

Aspect 11: The method of any of aspects 1 through 10, further comprising: receiving a second demodulation reference signal that is quasi co-located with the synchronization signal block or channel state information reference signal and associated with the physical downlink shared channel; and transmitting a second hybrid automatic repeat request acknowledgment message comprising a third indication of channel quality associated with the second demodulation reference signal of the physical downlink shared channel, wherein the third indication of channel quality comprises a differential measurement that is relative to the second indication of channel quality or the first indication of channel quality.

Aspect 12: The method of aspect 11, further comprising: receiving a third demodulation reference signal that is quasi co-located with the synchronization signal block or channel state information reference signal and associated with the physical downlink shared channel; and transmitting a third hybrid automatic repeat request acknowledgment message comprising a fourth indication of channel quality associated with the third demodulation reference signal of the physical downlink shared channel, wherein the fourth indication of channel quality comprises a differential measurement that is relative to the third indication of channel quality, the second indication of channel quality, or the first indication of channel quality.

Aspect 13: The method of any of aspects 1 through 12, wherein the first indication of channel quality, the second indication of channel quality, or both, comprise a layer one reference signal received power, a layer one signal to interference and noise ratio, a channel quality indicator, or any combination thereof.

Aspect 14: A method for wireless communications at a UE, comprising: receiving a synchronization signal block or channel state information reference signal; transmitting a channel state information report comprising a first indication of channel quality; receiving control signaling indicating that the UE is to provide differential reporting of channel quality based at least in part on at least one demodulation reference signal associated with a physical downlink shared channel; receiving the demodulation reference signal that is quasi co-located with the synchronization signal block or channel state information reference signal and associated with the physical downlink shared channel; and transmitting a second channel state information report comprising a second indication of channel quality associated with the demodulation reference signal of the physical downlink shared channel based at least in part on receiving the control signaling, wherein the second indication of channel quality comprises a differential measurement that is relative to the first indication of channel quality.

Aspect 15: The method of aspect 14, further comprising: receiving the control signaling comprising a downlink grant for a downlink transmission, wherein the demodulation reference signal is associated with the downlink transmission.

Aspect 16: The method of any of aspects 14 through 15, further comprising: receiving the control signaling comprising an uplink grant; receiving radio resource control signaling indicating a channel state information report configuration that indicates one or more demodulation reference signals upon which the second indication of channel quality is to be based, wherein the one or more demodulation reference signals are only quasi co-located with the synchronization signal block or channel state information reference signal; wherein the second indication of channel quality is based at least in part on the indicated one or more demodulation reference signals and the synchronization signal block or channel state information reference signal.

Aspect 17: The method of any of aspects 14 through 16, further comprising: receiving the control signaling comprising an uplink grant and an indication that the UE is to provide the differential reporting of channel based at least in part on the synchronization signal block or channel state information reference signal.

Aspect 18: The method of any of aspects 14 through 17, further comprising: receiving the demodulation reference signal during a time period that occurs before receiving the control signaling.

Aspect 19: The method of any of aspects 14 through 18, further comprising: transmitting the second channel state information report via a second part of a two-part channel state information report.

Aspect 20: The method of any of aspects 14 through 19, further comprising: receiving radio resource control signaling comprising a channel state information report configuration indicating that the UE is to provide periodic channel state information reports comprising differential reporting of channel state information associated with the physical downlink shared channel; and transmitting the periodic channel state information reports based at least in part on receiving the radio resource control signaling, each periodic channel state information report comprising an indication of channel quality of the physical downlink shared channel based at least in part on a last-received demodulation reference signal.

Aspect 21: The method of aspect 20, further comprising: wherein the channel state information report configuration indicates that the differential measurement is to be made relative to the first indication of channel quality.

Aspect 22: The method of any of aspects 14 through 21, further comprising: transmitting the second channel state information report, wherein the second indication of channel quality is based at least in part on an average of a signal strength of the demodulation reference signal and signal strengths of one or more additional demodulation reference signals that are quasi co-located with the synchronization signal block or channel state information reference signal and received after a most-recently transmitted previous channel state information report and before a time buffer that precedes transmitting the second channel state information report.

Aspect 23: The method of any of aspects 14 through 22, further comprising: receiving one or more additional demodulation reference signals during an averaging time window delineated by a beginning symbol and an end symbol, the one or more additional demodulation reference signals that are quasi co-located with the synchronization signal block or channel state information reference signal and associated with the same or additional physical downlink shared channel, wherein the second indication of channel quality is based at least in part on an average of a signal strength of the demodulation reference signal and signal strengths of at least one of the one or more additional demodulation reference signals.

Aspect 24: The method of any of aspects 14 through 23, further comprising: wherein the demodulation reference signal is received during a time window delineated by a beginning symbol and an end symbol.

Aspect 25: The method of any of aspects 14 through 24, wherein the first indication of channel quality, the second indication of channel quality, or both, comprise a layer one reference signal received power, a layer one signal to interference and noise ratio, a channel quality indicator, or any combination thereof.

Aspect 26: An apparatus for wireless communications at a UE, comprising a processor; memory coupled with the processor; and instructions stored in the memory and executable by the processor to cause the apparatus to perform a method of any of aspects 1 through 13.

Aspect 27: An apparatus for wireless communications at a UE, comprising at least one means for performing a method of any of aspects 1 through 13.

Aspect 28: A non-transitory computer-readable medium storing code for wireless communications at a UE, the code comprising instructions executable by a processor to perform a method of any of aspects 1 through 13.

Aspect 29: An apparatus for wireless communications at a UE, comprising a processor; memory coupled with the processor; and instructions stored in the memory and executable by the processor to cause the apparatus to perform a method of any of aspects 14 through 25.

Aspect 30: An apparatus for wireless communications at a UE, comprising at least one means for performing a method of any of aspects 14 through 25.

Aspect 31: A non-transitory computer-readable medium storing code for wireless communications at a UE, the code comprising instructions executable by a processor to perform a method of any of aspects 14 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive a synchronization signal block or channel state information reference signal;
transmit a channel state information report comprising a first indication of channel quality associated with the synchronization signal block or channel state information reference signal;
receive a demodulation reference signal that is quasi co-located with the synchronization signal block or channel state information reference signal and associated with a physical downlink shared channel; and
transmit a hybrid automatic repeat request acknowledgment message comprising a second indication of channel quality associated with the demodulation reference signal of the physical downlink shared channel, wherein the second indication of channel quality comprises a differential measurement that is relative to the first indication of channel quality.

2. The apparatus of claim 1, wherein the instructions are further executable by the processor to cause the apparatus to:
receive downlink control information indicating that the UE is to provide differential reporting of channel quality associated with the physical downlink shared channel, wherein transmitting the hybrid automatic repeat request acknowledgment message is based at least in part on receiving the downlink control information.

3. The apparatus of claim 2, wherein the downlink control information comprises a field that indicates a quantity of bits for transmitting the hybrid automatic repeat request acknowledgment message.

4. The apparatus of claim 1, wherein the instructions are further executable by the processor to cause the apparatus to:
receive radio resource control signaling associated with a hybrid automatic repeat request process identifier, the radio resource control signaling indicating that the UE is to provide differential reporting of channel quality associated with the physical downlink shared channel, wherein transmitting the hybrid automatic repeat request acknowledgment message is based at least in part on receiving the radio resource control signaling.

5. The apparatus of claim 4, wherein the radio resource control signaling indicates a quantity of bits for transmitting the hybrid automatic repeat request acknowledgment message.

6. The apparatus of claim 1, wherein the instructions to transmit the hybrid automatic repeat request acknowledgment message are executable by the processor to cause the apparatus to:
transmit a multi-bit field comprising a first bit that indicates a positive acknowledgement or a negative acknowledgment and a second bit that indicates the differential measurement.

7. The apparatus of claim 6, wherein the second bit of the multi-bit field indicates that a signal strength of the demodulation reference signal is higher than, lower than, or equal to a signal strength associated with the first indication of channel quality.

8. The apparatus of claim 6, wherein the second bit of the multi-bit field indicates that a signal strength of the demodulation reference signal differs from a signal strength associated with the first indication of channel quality by a value that is less than, equal to, or greater than a threshold value.

9. The apparatus of claim 1, wherein the instructions are further executable by the processor to cause the apparatus to:
receive one or more additional demodulation reference signals during an averaging time window defined by a beginning symbol and an end symbol, the one or more additional demodulation reference signals being quasi co-located with the synchronization signal block or channel state information reference signal and associated with the same or another physical downlink shared channel, wherein the second indication of channel quality is based at least in part on an average of a signal strength of the demodulation reference signal and signal strengths of at least one of the one or more additional demodulation reference signals.

10. The apparatus of claim 1, wherein the demodulation reference signal is received during a time window delineated by a beginning symbol and an end symbol.

11. The apparatus of claim 1, wherein the instructions are further executable by the processor to cause the apparatus to:
receive a second demodulation reference signal that is quasi co-located with the synchronization signal block or channel state information reference signal and associated with the physical downlink shared channel; and
transmit a second hybrid automatic repeat request acknowledgment message comprising a third indication of channel quality associated with the second demodulation reference signal of the physical downlink shared channel, wherein the third indication of channel quality comprises a differential measurement that is relative to the second indication of channel quality or the first indication of channel quality.

12. The apparatus of claim 11, wherein the instructions are further executable by the processor to cause the apparatus to:
receive a third demodulation reference signal that is quasi co-located with the synchronization signal block or channel state information reference signal and associated with the physical downlink shared channel; and
transmit a third hybrid automatic repeat request acknowledgment message comprising a fourth indication of channel quality associated with the third demodulation reference signal of the physical downlink shared channel, wherein the fourth indication of channel quality comprises a differential measurement that is relative to the third indication of channel quality, the second indication of channel quality, or the first indication of channel quality.

13. The apparatus of claim 1, wherein the first indication of channel quality, the second indication of channel quality, or both, comprise a layer one reference signal received power, a layer one signal to interference and noise ratio, a channel quality indicator, or any combination thereof.

14. An apparatus for wireless communications at a user equipment (UE), comprising:
a processor;
memory coupled with the processor; and
instructions stored in the memory and executable by the processor to cause the apparatus to:
receive a synchronization signal block or channel state information reference signal;
transmit a channel state information report comprising a first indication of channel quality;
receive control signaling indicating that the UE is to provide differential reporting of channel quality based at least in part on at least one demodulation reference signal associated with a physical downlink shared channel;
receive a demodulation reference signal that is quasi co-located with the synchronization signal block or channel state information reference signal and associated with the physical downlink shared channel; and
transmit a second channel state information report comprising a second indication of channel quality associated with the demodulation reference signal of the physical downlink shared channel based at least in part on receiving the control signaling, wherein the second indication of channel quality comprises a differential measurement that is relative to the first indication of channel quality.

15. The apparatus of claim 14, wherein the instructions are further executable by the processor to cause the apparatus to:
receive the control signaling comprising a downlink grant for a downlink transmission, wherein the demodulation reference signal is associated with the downlink transmission.

16. The apparatus of claim 14, wherein the instructions are further executable by the processor to cause the apparatus to:
receive the control signaling comprising an uplink grant; and
receive radio resource control signaling indicating a channel state information report configuration that indicates one or more demodulation reference signals upon which the second indication of channel quality is to be based, wherein the one or more demodulation reference signals are only quasi co-located with the synchronization signal block or channel state information reference signal;
wherein the second indication of channel quality is based at least in part on the indicated one or more demodulation reference signals and the synchronization signal block or channel state information reference signal.

17. The apparatus of claim 14, further comprising:
receiving the control signaling comprising an uplink grant and an indication that the UE is to provide the differential reporting of channel based at least in part on the synchronization signal block or channel state information reference signal.

18. The apparatus of claim 14, wherein the instructions are further executable by the processor to cause the apparatus to:
receive the demodulation reference signal during a time period that occurs before receiving the control signaling.

19. The apparatus of claim 14, wherein the instructions are further executable by the processor to cause the apparatus to:
transmit the second channel state information report via a second part of a two-part channel state information report.

20. The apparatus of claim 14, wherein the instructions are further executable by the processor to cause the apparatus to:
receive radio resource control signaling comprising a channel state information report configuration indicating that the UE is to provide periodic channel state information reports comprising differential reporting of channel state information associated with the physical downlink shared channel; and
transmit the periodic channel state information reports based at least in part on receiving the radio resource control signaling, each periodic channel state information report comprising an indication of channel quality of the physical downlink shared channel based at least in part on a last-received demodulation reference signal.

21. The apparatus of claim 20, wherein the instructions are further executable by the processor to cause the apparatus to:
wherein the channel state information report configuration indicates that the differential measurement is to be made relative to the first indication of channel quality.

22. The apparatus of claim 14, wherein the instructions are further executable by the processor to cause the apparatus to:
transmit the second channel state information report, wherein the second indication of channel quality is based at least in part on an average of a signal strength of the demodulation reference signal and signal strengths of one or more additional demodulation reference signals that are quasi co-located with the synchronization signal block or channel state information reference signal and received after a most-recently transmitted previous channel state information report and before a time buffer that precedes transmitting the second channel state information report.

23. The apparatus of claim 14, wherein the instructions are further executable by the processor to cause the apparatus to:
receive one or more additional demodulation reference signals during an averaging time window delineated by a beginning symbol and an end symbol, the one or more additional demodulation reference signals that are quasi co-located with the synchronization signal block or channel state information reference signal and associated with the same or additional physical downlink shared channel, wherein the second indication of channel quality is based at least in part on an average of a signal strength of the demodulation reference signal and signal strengths of at least one of the one or more additional demodulation reference signals.

24. The apparatus of claim 14, wherein:
the demodulation reference signal is received during a time window delineated by a beginning symbol and an end symbol.

25. The apparatus of claim 14, wherein the first indication of channel quality, the second indication of channel quality, or both, comprise a layer one reference signal received power, a layer one signal to interference and noise ratio, a channel quality indicator, or any combination thereof.

26. A method for wireless communications at a user equipment (UE), comprising:
receiving a synchronization signal block or channel state information reference signal;
transmitting a channel state information report comprising a first indication of channel quality associated with the synchronization signal block or channel state information reference signal;
receiving a demodulation reference signal that is quasi co-located with the synchronization signal block or channel state information reference signal and associated with a physical downlink shared channel; and
transmitting a hybrid automatic repeat request acknowledgment message comprising a second indication of channel quality associated with the demodulation reference signal of the physical downlink shared channel, wherein the second indication of channel quality comprises a differential measurement that is relative to the first indication of channel quality.

27. The method of claim 26, further comprising:
receiving downlink control information indicating that the UE is to provide differential reporting of channel quality associated with the physical downlink shared channel, wherein transmitting the hybrid automatic repeat request acknowledgment message is based at least in part on receiving the downlink control information.

28. The method of claim 26, further comprising:
receiving one or more additional demodulation reference signals during an averaging time window defined by a beginning symbol and an end symbol, the one or more additional demodulation reference signals being quasi co-located with the synchronization signal block or channel state information reference signal and associated with the same or another physical downlink shared channel, wherein the second indication of channel quality is based at least in part on an average of a signal strength of the demodulation reference signal and signal strengths of at least one of the one or more additional demodulation reference signals.

29. A method for wireless communications at a user equipment (UE), comprising:
receiving a synchronization signal block or channel state information reference signal;
transmitting a first channel state information report comprising a first indication of channel quality;
receiving control signaling indicating that the UE is to provide differential reporting of channel quality based at least in part on a demodulation reference signal associated with a physical downlink shared channel;
receiving the demodulation reference signal that is quasi co-located with the synchronization signal block or channel state information reference signal and associated with the physical downlink shared channel; and
transmitting a second channel state information report comprising a second indication of channel quality associated with the demodulation reference signal of the physical downlink shared channel based at least in part on receiving the control signaling, wherein the second indication of channel quality comprises a differential measurement that is relative to the first indication of channel quality.

30. The method of claim 29, further comprising:
receiving radio resource control signaling comprising a channel state information report configuration indicating that the UE is to provide periodic channel state information reports comprising differential reporting of channel state information associated with the physical downlink shared channel; and
transmitting the periodic channel state information reports based at least in part on receiving the radio resource control signaling, each periodic channel state information report comprising an indication of channel quality of the physical downlink shared channel based at least in part on a last-received demodulation reference signal.
